(19) United States
(12) Patent Application Publication
(10) Pub. No.: US 2010/0062187 A1
(43) Pub. Date: Mar. 11, 2010

(54) ANTI-GLARE FILM AND PROCESS FOR PRODUCING THE SAME

(76) Inventors: Hiroshi Takahashi, Himeji-shi (JP); Shinichi Morisuna, Himeji-shi (JP)

Correspondence Address: BIRCH STEWART KOLASCH & BIRCH, PO BOX 747, FALLS CHURCH, VA, 22040-0747, US

(21) Appl. No.: 12/556,160

(22) Filed: Sep. 9, 2009

(30) Foreign Application Priority Data
Sep. 10, 2008 (JP) 232197/2008

(51) Int. Cl. B32B 27/08; B05D 1/36; C09K 19/00

(52) U.S. Cl. 428/1.1; 428/483; 427/393.5

(57) ABSTRACT

An anti-glare film comprises a substrate film comprising a cycloolefinic polymer, an anti-glare layer, and an adhesive layer formed between the substrate film and the anti-glare layer. In the anti-glare film, the adhesive layer is (A-1) a cured layer of (A-2) a curable composition containing at least (A-3) a curable component selected from the group consisting of a mono- or di(meth)acrylate having an alicyclic hydrocarbon ring and a mono- or di(meth)acrylate having a crosslinked cyclic hydrocarbon ring; the anti-glare layer is (B-1) a cured layer of (B-2) a curable resin composition and has a phase separation structure and an uneven surface structure, and the curable resin composition (B-2) comprises a plurality of components being capable of phase separation and containing at least (B-3) a curable component.

### FIELD OF THE INVENTION

The present invention relates to an anti-glare film suitably usable in various displays (e.g., a liquid crystal display) for computers, word processors, televisions, portable telephones (or cellular phones), mobile electronic devices, and others, a process for producing the same, and a display apparatus provided with (or equipped with) the anti-glare film. More specifically, the present invention relates to an anti-glare film comprising an anti-glare layer and a transparent substrate film comprising a cycloolefinic polymer, a process for producing the same, and a display apparatus provided with (or equipped with) the anti-glare film.

### BACKGROUND OF THE INVENTION

In recent years, various displays such as a liquid crystal display, a plasma display, an organic EL (electroluminescence) display, an inorganic EL display and a FED (field emission display) have been developed. In particular, remarkable progress as a display apparatus has been made in thinner liquid crystal displays for floor type (or stationary) television (TV) application or mobile application, and the liquid crystal display has become rapidly popular. For example, regarding movie display performances, the development of a liquid crystal material having a high-speed responsiveness or the improvement of a drive system such as overdrive has overcome weak points (poor movie display) of a conventional liquid crystal, and the technical innovation supporting the increase in display size and the reduction in thickness of the display has progressed.

The display surfaces of these displays are usually subjected to a surface treatment for inhibiting reflection of an ambient light (sun light or light from a light source around the display) on a surface in order to use the displays for an application requiring a high image quality (e.g., a television and a monitor) and a mobile application in which the displays are used in open air under a strong ambient light (e.g., a portable telephone, a digital camera, a video camera, and a car navigation system). One of the means for inhibiting reflection of the ambient light is an anti-glare treatment. For example, a surface of a liquid crystal display is often subjected to the anti-glare treatment. The anti-glare treatment forms a finely uneven structure on the surface of the display so as to scatter a light reflected from the surface and to blur a reflected image on the surface. Therefore, unlike a clear anti-reflection film, the anti-glare layer inhibits the reflected images of a viewer and a background, and the light reflected on the anti-glare layer hardly tends to interfere with a projected image. For example, Japanese Patent Application Laid-Open No. 337734/1999 (JP-11-337734A, Patent Document 1) discloses a conductive polarization plate comprising a polarizing membrane and a transparent conductive layer disposed directly thereon or through at least one surface-treated layer thereto, the transparent conductive layer having a surface electrical resistance of 10³Ω/□ to 10⁶Ω/□. This document also discloses that the surface-treated layer is a surface-protective layer and/or an antiglare-treated layer. The document further discloses that the antiglare-treated layer is formed by spin-coating a dispersion containing fine particles having a high refraction index dispersed in a resin solution or by spin-coating only an acrylic resin and then directly imparting irregularity to the surface mechanically or chemically. Japanese Patent Application Laid-Open No. 215307/2001 (JP-2001-215307A, Patent Document 2) discloses an anti-glare layer containing a transparent fine particle having a mean particle size of not larger than 15 μm in a coat layer whose thickness is not less than twice as large as the mean particle size, wherein the transparent fine particles are contained in the coat layer so as to be localized in one side being in contact with air, thereby forming a finely uneven structure.

Japanese Patent Application Laid-Open No. 206499/2007 (JP-2007-206499A, Patent Document 3) discloses an anti-glare film comprising a transparent film of a cycloolefinic resin and a particle-containing protective layer laminated on the surface of the transparent film, the particle-containing protective layer being a photo-cured layer of a composition containing an active (or actinic) energy ray-curable resin composition and an agglomerated particle having a mean particle size of 50 to 600 nm. The surface of the anti-glare film has a maximum height roughness Ry of 1.0 to 3.2 μm, the anti-glare film has an image clarity of not less than 18%, and the active energy ray-curable resin composition contains (A) 40 to 60% by weight of a polyfunctional monomer having a surface tension of not more than 37 mN/m and three or more acryloyl groups, (B) 10 to 60% by weight of a polymer obtained by addition reaction of acrylic acid to a glycidyl (meth)acrylate-series polymer and optionally (C) 0 to 50% by weight of other acrylic oligomers. The document also discloses that the polyfunctional monomer as the component (A) is trimethylolpropane triacrylate and/or ditrimethylolpropane tetraacrylate and that the curable resin composition contains trimethylolpropane triacrylate in a proportion of 50% by weight in the total components (A) to (C) in Example 1. Moreover, the document describes that in the formed protective layer a particle having a particle size of not smaller than 1300 nm is contained in a proportion of 1.5 to 7% in the total amount of particles.

However, these uneven surfaces of the anti-glare layers of the anti-glare films for imparting anti-glareness increase scattering of light from the surface accordingly, and thus the scattered light is mixed with the reflected light to make a black image whitish. In addition, light is scattered by fine particles with different refraction index existing in the anti-glare layer to generate haze (internal haze), whereby the total haze of the film is increased, a display image is wholly whitish to induce decrease in the contrast of the display image. Further, since the fine particles are liable to aggregate, it is difficult to control the uneven surface structure, and the flexibility of design for the uneven surface structure is limited. Furthermore, the aggregation of the fine particles induces irregularity and the like, thereby causing an unsatisfactory external appearance of the film.

On the other hand, a poly(ethylene terephthalate) (PET) film as an optical transparent film, and particularly, a cellulose acetate film (TAC film) as a protective film has been widely used for polarizing plate of a liquid crystal. In recent years, an optical transparent film formed from a cycloolefinic polymer has been used in a wider application as a material having excellent transparency, heat resistance, moisture resistance, and birefringence. However, there are problems as follows: a molded product of the cycloolefinic polymer usually has an insufficient surface wettability and is inferior in adhesiveness to other members or adhesion to a coating agent for imparting another function to the film surface.

Regarding improvement in adhesiveness to the cycloolefinic polymer film, for example, Japanese Patent Application Laid-Open No. 306378/1993 (JP-5-306378A, Patent Document 4) discloses that an ultra violet-curable composition comprising a monofunctional acrylate monomer, a bi- or trifunctional acrylate monomer, a tetra- or more functional acrylate monomer, and a photopolymerization initiator is applied on a surface of a molded product formed from a thermoplastic saturated norbornene-series resin and is irradiated by ultra violet ray to form a coat layer (hardcoat layer). This document also discloses an ultra violet-curable composition containing a monomer selected from the group consisting of a long-chain aliphatic monofunctional acrylate monomer, an alicyclic monofunctional acrylate monomer, and an alicyclic bifunctional acrylate monomer in a proportion of not less than 40% by weight. Example 1 of the document describes that an ultra violet-curable composition containing trimethylolpropane triacrylate in a proportion of about 30% by weight is used to form the coat layer having a pencil hardness of 3H and an adhesion strength of 96% according to a cross-cut test. Japanese Patent Application Laid-Open No. 12787/1996 (JP-8-12787A, Patent Document 5) discloses a thermoplastic norbornene-series resin molded product having a hardcoat layer formed by curing an ultra violet-curable composition comprising the following components (A) to (C): (A) 10 to 90 parts by weight of a monomer mixture containing (a-1) 20 to 100% by weight of a polyfunctional monomer having three or more (meth)acryloyloxy groups per molecule and (a-2) 80 to 0% by weight of a mono- to bifunctional monomer having one or two (meth)acryloyloxy group(s) per molecule, (B) 5 to 80 parts by weight of a paint resin comprising a homopolymer or copolymer of a vinyl-series monomer containing not less than 10% by weight of at least one monomer selected from the group consisting of (meth)acrylic acid esters, and (C) 0.1 to 15 parts by weight of a photopolymerization initiator. The document discloses trimethylolpropane tri(meth)acrylate as an example of the polyfunctional monomer (a-1) and describes in Examples that an ultra violet-curable composition containing trimethylolpropane triacrylate in a proportion of about 30% by weight in the monomer mixture (A). Japanese Patent Application Laid-Open No. 223341/1991 (JP-3-223341A, Patent Document 6) discloses a method comprising applying an ultra violet-curable hardcoat agent containing an aromatic hydrocarbon-series solvent and/or an alicyclic hydrocarbon-series solvent on a surface of a thermoplastic saturated norbornene-series polymer molded product, drying the coated layer, and irradiating ultra violet ray on the dried coat layer to form a hardcoat layer (excluding a silicone-series hardcoat layer) having an adhesive strength of not less than 90% according to a cross-cut test and a surface hardness (pencil hardness) of not less than 3H. However, these hardcoat agents cannot impart anti-glareness to the molded product or the film.

Japanese Patent Application Laid-Open No. 106290/2006 (JP-2006-106290A, Patent Document 7) discloses, as an anti-glare film having a slight internal haze, an anti-glare film comprising an anti-glare layer and a low-refraction-index resin layer formed on at least one surface of the anti-glare layer, wherein the anti-glare layer has an uneven surface structure, the total haze is 1 to 30%, and the internal haze is 0 to 1%; and the anti-glare film having the anti-glare layer and the low-refraction-index resin layer formed sequentially on a transparent support. The document also discloses that an anti-glare layer having a regular phase separation structure and an uneven surface structure corresponding to the phase separation structure can be formed by applying a liquid coating composition containing at least one polymer and at least one curable resin precursor on a surface of the support, phase-separating the polymer and the resin precursor due to spinodal decomposition in the evaporation process of a solvent from the coated layer, and curing the resin precursor, and that a display apparatus comprising such an anti-glare film ensures a clear image quality without blur of characters (unsharp characters or letters) and concurrently realizes good anti-glare effects without washing out or whitening (white blur). This document, JP-2006-106290A, describes a cyclic polyolefinic resin as a resin for the transparent support, and Examples of the document also describes that an acrylic resin having a polymerizable unsaturated group at a side chain thereof, a cellulose acetate propionate, dipentaerythritol hexaacrylate (DPHA) or an aromatic urethane acrylate (EB220), and a photoinitiator are dissolved in a solvent, and the resulting liquid coating composition is used to form an anti-glare layer. However, the document is silent on adhesiveness of an anti-glare layer relative to a transparent film formed from a cycloolefinic polymer.

[Patent Document 1] JP-11-337734A (Claims)

[Patent Document 2] JP-2001-215307A (Claims)

[Patent Document 3] JP-2007-206499A (Claims and Example 1)

[Patent Document 4] JP-5-306378A (Claims and Example 1)

[Patent Document 5] JP-8-12787A (Claims and Paragraph [0018])

[Patent Document 6] JP-3-223341A (Claims)

[Patent Document 7] JP-2006-106290A (Claims, Paragraphs [0018], [0087], [Effects of the Invention], and Examples)

### SUMMARY OF THE INVENTION

It is therefore an object of the present invention to provide an anti-glare film comprising an anti-glare layer having a high adhesiveness relative to a cycloolefinic polymer film, a process for producing the anti-glare film, and a display apparatus (or device) provided with the anti-glare film.

An other object of the present invention is to provide an anti-glare film having an anti-glare layer which serves as a hardcoat layer and has a high adhesiveness relative to a substrate film with retaining a high transparency, which is one of characteristics of cycloolefinic polymers, a process for producing the anti-glare film, and a display apparatus (or device) provided with the anti-glare film.

It is still another object of the present invention to provide an anti-glare film which can prevent a reflection of an ambient light and dazzle and provide an image in which a black color is clear or sharp (or a clear or sharp image having a black color), a process for producing the anti-glare film, and a display apparatus (or device) provided with the anti-glare film.

It is a further object of the present invention to provide an anti-glare film which has a fine and regular uneven surface structure without using an uneven surface structure formed by fine particles and has an excellent anti-glareness, a process for producing the anti-glare film, and a display apparatus (or device) provided with the anti-glare film.

The inventors of the present invention made intensive studies to achieve the above objects and finally found that an anti-glare layer having a phase separation structure having regularity and an uneven surface structure corresponding to the phase separation structure can be adhered to a substrate film with a high adhesiveness by applying a curable composition containing a (meth)acrylate having an alicyclic hydrocarbon ring or a crosslinked cyclic hydrocarbon ring as a curable component on the surface of the substrate film comprising a cycloolefinic polymer, applying a uniform solution of a curable composition containing a plurality of components being capable of phase separation (or being phase-separable) and containing at least one curable component (for example, a composition containing at least one polymer component and at least one curable resin precursor) on the coated layer, forming a phase separation structure by phase separation with evaporating the solvent from the coated layer, and curing (or hardening) the curable components. The present invention was accomplished based on the above findings.

That is, the anti-glare film of the present invention comprises a substrate film comprising a cycloolefinic polymer, an anti-glare layer, and an adhesive layer formed between (or interposed between) the substrate film and the anti-glare layer. The adhesive layer is (A-1) a cured layer of (A-2) a curable composition containing at least one of a curable component, the curable component comprises at least (A-3) a ring-containing curable component selected from the group consisting of a mono- or di(meth)acrylate having an alicyclic hydrocarbon ring and a mono- or di(meth)acrylate having a crosslinked cyclic hydrocarbon ring; and the anti-glare layer is (B-1) a cured layer of (B-2) a curable resin composition which comprises a plurality of components being capable of phase separation (from each other) and containing at least (B-3) a curable component, and the anti-glare layer has a phase separation structure and an uneven surface structure (or a surface structure having a raised portion and an indentation portion, a surface structure having a convex portion and a concave portion).

The curable composition (A-2) for forming the adhesive layer may contain a di(meth)acrylate having a crosslinked cyclic hydrocarbon ring (e.g., tricyclodecanedimethaol di(meth)acrylate) as the curable component. The proportion of the ring-containing curable component (A-3) (e.g., tricyclodecanedimethaol di(meth)acrylate) in the total curable component (including, e.g., an active energy ray-curable resin precursor having a photopolymerizable group) of the curable composition (A-2) may be not less than 30% by weight. The curable composition (A-2) for forming the adhesive layer may further contain a cellulose derivative. For example, the adhesive layer may be formed with a (meth)acrylate having an alicyclic hydrocarbon ring or a crosslinked cyclic hydrocarbon ring (e.g., tricyclodecanedimethaol di(meth)acrylate) and a cellulose ester.

The anti-glare layer may comprise an active energy ray-curable resin precursor having a plurality of photopolymerizable groups as a curable component and at least one polymer component. At least two components of the curable resin precursor and the polymer component may form a phase separation structure due to phase separation from a liquid phase, and the curable resin precursor may be cured (or may have been cured). The curable resin precursor may contain a polyfunctional (meth)acrylate having a plurality of (meth)acryloyl groups. The polymer component may contain a cellulose derivative and a polymer having a (meth)acryloyl group. Moreover, the polymer component may comprise a plurality of polymers (for example, a cellulose derivative and at least one resin selected from the group consisting of a styrenic resin, a (meth)acrylic resin, a cycloolefinic resin, a polycarbonate-series resin, and a polyester-series resin, usually, may contain the cellulose derivative and the polymer having a (meth)acryloyl group. Among the plurality of polymer components, at least one polymer component may have a functional group participating in a curing (or hardening) reaction of the curable resin precursor (for example, a polymeric able group such as (meth)acryloyl group). For example, the anti-glare layer may be formed with a composition comprising a polyfunctional (meth)acrylate, a cellulose ester, and a polymer component having a (meth)acryloyl group at a side chain thereof.

The anti-glare film may isotropically transmit and scatter an incident light to show a maximum value of a scattered light intensity at a scattering angle of 0.1 to 10° and have a total light transmittance of 80 to 100%. The anti-glare film may have a total haze of 1 to 25%, an internal haze of 0 to 1%, and a transmitted image clarity of 25 to 75% measured with an image clarity measuring apparatus provided with an optical slit of 0.5 mm width. The anti-glare layer in such an anti-glare film has a high hardness and hardcoat property (or abrasion or scratch resistance) and is adhered to the substrate film with a high adhesion strength. For example, the anti-glare layer may have a residual ratio of a cross-cut area of not less than 90% in accordance with a cross-cut test and a pencil hardness of not lower than H. Incidentally, the anti-glare layer may have a fixed (or immobilized) regular or periodic phase separation structure due to (or caused by) the curing (or hardening) of the curable resin precursor. Moreover, the anti-glare layer may be cured by, for example, an active energy ray (such as ultra violet ray or electron beam), heat, and other means.

The anti-glare film of the present invention may be produced by

an applying step for applying a first liquid coating composition (or a first coating liquid) on a surface of a substrate film comprising a cycloolefinic polymer,
the first liquid coating composition comprising a curable composition containing at least one curable component selected from the group consisting of a mono- or di(meth)acrylate having an alicyclic hydrocarbon ring and a mono- or di(meth)acrylate having a crosslinked cyclic hydrocarbon ring,

an applying step for applying a second liquid coating composition (or a second coating liquid) on the coated surface,
the second liquid coating composition comprising a curable resin composition containing a plurality of components and a solvent, and the plurality of components being capable of phase separation and containing at least one curable component,

a phase-separation step for forming a phase separation structure by phase separation with evaporating the solvent, and

a step for curing (or hardening) the curable components of each of the first and second compositions.

The curing forms a phase separation structure and can produce an anti-glare layer having an uneven surface structure. Incidentally, on the substrate film, after forming the cured adhesive layer, the anti-glare layer having a phase separation structure may be formed. The adhesive layer and the anti-glare layer may be formed by applying the first liquid coating composition and the second liquid coating composition on the surface of the substrate film in this order, forming a phase separation structure of the second liquid coating composition, and curing (or hardening) the coated layers.

In the production process, the first liquid coating composition for an adhesive layer may contain a di(meth)acrylate having a crosslinked cyclic hydrocarbon ring (e.g., tricyclodecanedimethaol di(meth)acrylate), a cellulose derivative, a photopolymerization initiator, and a first solvent dissolving these components, and the second liquid coating composition for an anti-glare layer may contain a polyfunctional (meth)acrylate having a plurality of (meth)acryloyl groups, a cellulose derivative, a polymer component having a (meth)acryloyl group, a photopolymerization initiator, and a second solvent dissolving these components. The curing may be carried out with light irradiation. The curing step may be carried out at least after the phase-separation step. The production process may further comprise a drying step for drying a coated layer of the first liquid coating composition for forming a first layer, and an evaporating step for evaporating the second solvent from a coated layer of the second liquid coating composition for forming a second layer having the phase separation structure, and the curing step may comprise (1) a first step for curing the first layer and a second step for curing the second layer or (2) a step for curing the first layer and the second layer. Incidentally, if necessary, the substrate film may be subjected to a corona discharge treatment before the step for applying the first liquid coating composition. According to the present invention, the anti-glare layer can be adhered to the substrate film with a high adhesion strength without any surface treatment of the substrate film. Therefore, the anti-glare film may be produced by applying the first and second liquid coating compositions without any surface treatment of the substrate film to form cured layers (the adhesive layer and the anti-glare layer).

The adhesive layer may or may not have a phase separation structure. The adhesive layer is usually free from a phase separation structure.

The anti-glare film can effectively prevent reflection of an ambient light in a display surface even when the anti-glare film is in the form of a single film. Therefore, the present invention also includes a display apparatus provided with the anti-glare film, for example, a display apparatus selected from the group consisting of a liquid crystal display, a cathode ray tube display, a plasma display, and a touch panel-equipped input device.

Throughout this specification, the term “(meth)acrylic acid” or “(meth)acrylate” may be used as a generic term for a methacrylic acid-series monomer and an acrylic acid-series monomer. Moreover, each of the terms “curable component” and “curable resin precursor” means a monomer or an oligomer and is distinguished from the term “polymer component” having a high molecular weight.

### BRIEF DESCRIPTION OF THE DRAWINGS

FIG. 1 represents a schematic view illustrating an apparatus for measuring a transmitted scattered-light profile (an angle distribution of a transmitted scattered-light).

FIG. 2 represents a graph representing results obtained from the measurements of an angle distribution of a transmitted scattered-light intensity in each of anti-glare films obtained in Examples 1 and 8.

FIG. 3 represents a laser reflection microphotograph of an uneven surface of an anti-glare film obtained in Example 1.

FIG. 4 represents a laser reflection microphotograph of an uneven surface of an anti-glare film obtained in Example 8.

### DETAILED DESCRIPTION OF THE INVENTION

### Anti-Glare Film

The anti-glare film comprises a substrate film comprising a cycloolefinic polymer, an adhesive layer formed on at least one surface of the substrate film, and an anti-glare layer formed on a surface of the adhesive layer. The adhesive layer is a cured layer of a curable composition containing a (meth)acrylate having an alicyclic hydrocarbon ring or a crosslinked cyclic hydrocarbon ring. In order to form a coated layer having a phase separation structure with a high hardness, the above anti-glare layer is formed with a curable resin composition containing a plurality of components capable of phase separation. Further, the inside of the anti-glare layer has a phase separation structure, and the anti-glare layer has an uneven structure at the outermost region (or surface). Thus the anti-glare layer scatters and reflects an external incident light to inhibit reflection or dazzle of an ambient light.

[Substrate Film]

The cycloolefinic polymer is a known polymer and may include a polymer of a norbornene-series monomer, a copolymer (COC) of a norbornene-series monomer and a copolymerizable monomer (e.g., an olefinic monomer), a hydrogenated polymer (COP) of a norbornene-series monomer, a modified product of each of these polymers, and others. The cycloolefinic polymer has a high transparency and a small birefringence. Incidentally, in order to improve the adhesiveness of the substrate film to the anti-glare film, the introduction of a functional group to the norbornene-series monomer has been extensively examined. However, the introduction of the functional group is disadvantageous with respect to costs. Moreover, the copolymer (COC) is obtained by one-step reaction and advantageous with respect to costs, compared with the hydrogenated polymer (COP), which is obtained by two-step reaction, that is, polymerization and hydrogenation. In view of these regards, it has been desirable to improve the adhesiveness of the coated layer to a molded product (the substrate film) of a relatively low-cost cycloolefinic polymer by improving a coating composition or an applying (or coating) method.

The norbornene-series monomer may include, for example, norbornene, a norbornene having a substituent (2-norbornene), an oligomer or polymer of cyclopentadiene, and an oligomer or polymer of a cyclopentadiene having a substituent. The substituent may include an alkyl group, an alkenyl group, an aryl group, a hydroxyl group, an alkoxy group, a carboxyl group, an alkoxycarbonyl group, an acyl group, a cyano group, an amide group, a halogen atom, and others.

Examples of such a norbornene-series monomer may include 2-norbornene; a norbornene having an alkyl group (e.g., 5-methyl-2-norbornene, 5,5-dimethyl-2-norbornene, 5-ethyl-2-norbornene, and 5-butyl-2-norbornene); a norbornene having an alkenyl group (e.g., 5-ethylidene-2-norbornene); a norbornene having an alkoxycarbonyl group (e.g., 5-methoxycarbonyl-2-norbornene and 5-methyl-5-methoxycarbonyl-2-norbornene); a norbornene having a cyano group (e.g., 5-cyano-2-norbornene); a norbornene having an aryl group (e.g., 5-phenyl-2-norbornene and 5-phenyl-5-methyl-2-norbornene); dicyclopentadiene; a derivative such as 2,3-dihydrodicyclopentadiene, methanooctahydrofluorene, dimethanooctahydronaphthalene, dimethanocyclopentadienonaphthalene, or methanooctahydrocyclopentadienonaphthalene; a derivative having a substituent (e.g., 6-ethyl-octahydronaphthalene); an adduct of cyclopentadiene and tetrahydroindene or the like, and a tri- to tetramer of cyclopentadiene. These monomers may be used alone or in combination.

The copolymerizable monomer may include a chain C₂₋₁₀olefin such as ethylene, propylene, 1-butene, isobutene, 1-pentene, 3-methyl-1-pentene, 4-methyl-1-pentene, 1-hexene, or 1-octene; a cyclic C₄₋₁₂ cycloolefin such as cyclobutene, cyclopentene, cycloheptene, cyclooctene, or dicyclopentadiene; a vinyl ester-series monomer (for example, vinyl acetate and vinyl propionate); a diene-series monomer (for example, butadiene and isoprene); a (meth)acrylic monomer (for example, (meth)acrylic acid, or a derivative thereof (e.g., a (meth)acrylic acid ester)), and others. These copolymerizable monomers may be used alone or in combination. The preferred copolymerizable monomer includes a chain α-C₂₋₈ olefin, particularly, a chain α-C₂₋₄ olefin such as ethylene.

The ratio of the norbornene-series monomer relative to the copolymerizable monomer [the former/the latter (molar ratio)] may be, for example, about 100/0 to 50/50, preferably about 100/0 to 60/40, and more preferably about 100/0 to 70/30.

The cycloolefinic polymer is easily available as the trade name “TOPAS” (manufactured by Polyplastics Co., Ltd.), the trade name “ZEONEX” (manufactured by Zeon Corporation), the trade name “ARTON” (manufactured by JSR Corporation), the trade name “APEL” (manufactured by Mitsui Petrochemical Industries, Ltd.), and others.

The molecular weight of the cycloolefinic polymer may be selected from the range of a number average molecular weight of about 0.5×10⁴ to 100×10⁴. The number average molecular weight may be, for example, about 1×10⁴ to 50×10⁴, and preferably about 2×10⁴ to 30×10⁴. The glass transition temperature (Tg) of the cycloolefinic polymer may be about 100 to 230° C., preferably about 120 to 200° C., and more preferably about 130 to 180° C.

The cycloolefinic polymer may contain a conventional additive, for example, a plasticizer, a coloring agent, a dispersing agent, a mold-release agent (releasing agent), a stabilizer (an antioxidant such as a hindered phenol-series antioxidant, a phosphorus-containing antioxidant, or a sulfur-containing antioxidant, an ultra violet ray absorbing agent, and a heat stabilizer), an antistatic agent, a flame retardant, an antiblocking agent, a crystal nucleus-growing agent, and a filler (e.g., a particulate filler such as a silica or a talc, and a fibrous filler such as a glass fiber or a carbon fiber). These additives may be used alone or in combination. Incidentally, in order to maintain a high transparency, the substrate film is usually free from an additive having some adverse effects on transparency, for example, a filler. The cycloolefinic polymer may be formed into a film by a conventional manner. For example, the substrate film may be produced by, for example, a film-forming method such as a solution casting method, a melt-extrusion method (e.g., a T-die method and an inflation method), a calender method, and a thermoforming method (particularly, a hot-press method). The substrate film is usually produced by a melt-extrusion method.

The substrate film may be stretched uniaxially or biaxially, and the substrate film having optical isotropy is preferred. The preferred substrate film is a support sheet or film having a low birefringence index. The thickness of the substrate film may be selected from the range of, for example, about 5 to 2000 μm, preferably about 15 to 1000 μm, and more preferably about 20 to 500 μm (for example, about 50 to 250 μm).

The surface wettability of the substrate film may be improved, with or without a surface treatment, to improve the adhesiveness relative to the anti-glare layer. The surface treatment may include, for example, a solvent treatment and an electrical surface treatment (e.g., a corona discharge treatment, a plasma treatment, a short-wavelength ultra violet irradiation treatment, and an electron irradiation treatment). For the surface treatment, an electric surface treatment, particularly a corona discharge treatment, is practically used.

[Adhesive Layer]

The curable component of the curable composition for forming the adhesive layer may be a thermosetting component or an active (or actinic) energy ray-curable component (a photo-curable component). The preferred curable component includes a photo-curable component curable by active (or actinic) energy ray irradiation. The curable component of the curable composition for forming the adhesive layer contains a (meth)acrylate having an alicyclic hydrocarbon ring or a crosslinked cyclic hydrocarbon ring (herein after, may simply be referred to as a first curable component). Such a first curable component may include, for example, a (meth)acrylate having an alicyclic hydrocarbon ring [a cycloalkyl (meth)acrylate (e.g., a C₅₋₁₂ cycloalkyl (meth)acrylate such as cyclohexyl (meth)acrylate or cyclooctyl (meth)acrylate); a (meth)acrylate having a crosslinked cyclic hydrocarbon ring (e.g., a bi- to tetracyclic C₇₋₁₂ cycloalkyl (meth)acrylate such as tricyclo[5,2,1,0^{2,6}]decanyl (meth)acrylate, isobornyl (meth)acrylate, or adamantyl (meth)acrylate); a di(meth)acrylate having an alicyclic hydrocarbon ring [e.g., cyclohexylene di(meth)acrylate and cyclohexanedimethaol di(meth)acrylate]; and a di(meth)acrylate having a crosslinked cyclic hydrocarbon ring [e.g., a bi- to tetracyclic C₇₋₁₂ cycloalkylene di(meth)acrylate such as tricyclodecanedimethaol di(meth)acrylate (dimethyloldicyclopentane di(meth)acrylate) or adamantane di(meth)acrylate]. These curable components may be used alone or in combination. A use of the curable component(s) can greatly improve the adhesiveness to the substrate film comprising a cycloolefinic polymer and form an adhesive layer having a high transparency. Therefore, the selection of the anti-glare layer component has no limitation, and a wide range of the anti-glare layer component can be used.

Among the first curable components, a di(meth)acrylate having an alicyclic hydrocarbon ring or crosslinked cyclic hydrocarbon ring, particularly, a di(meth)acrylate having a crosslinked cyclic hydrocarbon ring (among others, tricyclodecanedimethaol di(meth)acrylate (dimethyloldicyclopentane di(meth)acrylate)), is preferred.

The curable composition may further contain a second curable component (a thermosetting component or a photo-curable component, particularly, a photo-curable component). Such a curable component may include a monofunctional monomer [for example, a (meth)acrylic monomer such as a (meth)acrylic acid ester, e.g. an alkyl (meth)acrylate (e.g., a C₁₋₁₆alkyl (meth)acrylate such as methyl (meth)acrylate, ethyl (meth)acrylate, butyl (meth)acrylate, hexyl (meth)acrylate, lauryl (meth)acrylate, octyl (meth)acrylate, isooctyl (meth)acrylate, decyl (meth)acrylate, or isodecyl (meth)acrylate), a glycidyl (meth)acrylate, a hydroxyalkyl (meth)acrylate; and a vinyl-series monomer such as a vinyl ester (e.g., vinyl acetate) or vinylpyrrolidone], and a polyfunctional monomer having at least two polymerizable unsaturated bonds [e.g., an alkylene glycol di(meth)acrylate such as ethylene glycol di(meth)acrylate, propylene glycol di(meth)acrylate, butanediol di(meth)acrylate, neopentyl glycol di(meth)acrylate, or hexanediol di(meth)acrylate; a (poly)alkylene glycol di(meth)acrylate such as diethylene glycol di(meth)acrylate, dipropylene glycol di(meth)acrylate, or a polyoxytetramethylene glycol di(meth)acrylate; and a polyfunctional monomer having about 3 to 6 polymerizable unsaturated bonds, such as trimethylolethane tri(meth)acrylate, trimethylolpropane tri(meth)acrylate, 1,1,1-tri(2-hydroxyethoxymethyl)propane tri(meth)acrylate, pentaerythritol tri(meth)acrylate, pentaerythritol tetra(meth)acrylate, ditrimethylolpropane tetra(meth)acrylate, dipentaerythritol penta(meth)acrylate, or dipentaerythritol hexa(meth)acrylate].

The second curable component may be an oligomer or a resin. Examples of such a curable component may include a (meth)acrylate of an alkylene oxide adduct of bisphenol A, an epoxy (meth)acrylate (e.g., a bisphenol A-based epoxy (meth)acrylate, and a novolak-based epoxy (meth)acrylate), a polyester (meth)acrylate (e.g., an aliphatic polyester-based (meth)acrylate and an aromatic polyester-based (meth)acrylate), a (poly)urethane (meth)acrylate (e.g., a polyester-based urethane (meth)acrylate and a polyether-based urethane (meth)acrylate), a silicone (meth)acrylate, and others.

The preferred curable component includes a photo-curable component curable in a short time, for example, an ultra violet-curable component (e.g., a monomer, an oligomer, and a low molecular weight resin) and an EB-curable compound. Further, to improve resistance such as abrasion or scratch resistance, the photo-curable compound preferably includes a monomer having a plurality (preferably about 2 to 10 and more preferably about 2 to 6) of polymerizable unsaturated bonds (e.g., (meth)acryloyl group) per molecule, such as a polyfunctional (meth)acrylate. Incidentally, a compound having an acryloyl group is preferable as the photo-curable compound.

The proportion of the first curable component is not particularly limited to a specific one as long as the adhesive layer does not deteriorate the adhesiveness to the substrate film and the anti-glare layer. For example, the proportion of the first curable component may be selected from the range of not less than 10% by weight (for example, about 20 to 100% by weight) in total curable components (the total of the first and the second curable components or the total of an active energy ray-curable resin precursor having a photopolymerizable group) of the curable composition. The proportion of the first curable component is usually not less than 30% by weight (for example, about 40 to 100% by weight, preferably about 50 to 100% by weight, and more preferably about 60 to 100% by weight). The weight ratio of the first curable component relative to the second curable component [the former/the latter] may be about 30/70 to 100/0, preferably about 40/60 to 90/10, and more preferably about 50/50 to 80/20. When a bifunctional (meth)acrylate as the first curable component and a tri- to hexafunctional (meth)acrylate as the second curable component are used, a high proportion (e.g., about 50 to 100% by weight) of the first curable component advantageously improves the adhesiveness and prevents the anti-glare film from curling (or curving), and a low proportion (e.g., about 30 to 50% by weight) of the first curable component advantageously improves the hardness of the anti-glare film.

The curable composition may be used in combination with a curing agent depending on the species of the curable component. For example, a thermosetting component may be used in combination with a curing agent such as an amine or a polyfunctional carboxylic acid (or polycarboxylic acid), and a photo-curable component may be used in combination with a photopolymerization initiator.

The photopolymerization initiator may include a conventional component, e.g., an acetophenone (e.g., 2,2-dimethoxy-2-phenylacetophenone and 2,2-diethoxyacetophenone), a propiophenone, a benzyl, a benzoin (e.g., a benzoin alkyl ether), a benzophenone, a thioxanthone, an acylphosphine oxide, and others. The amount of the curing agent (such as the photopolymerization initiator), relative to 100 parts by weight of the curable component, may be about 0.1 to 20 parts by weight, preferably about 0.5 to 10 parts by weight, and more preferably about 1 to 8 parts by weight (particularly about 1 to 5 parts by weight).

Further, the curable composition may contain a curing accelerator, a crosslinking agent, a thermal-polymerization inhibitor, and others. For example, the photo-curable composition may be used in combination with a photo-curing accelerator, e.g., a tertiary amine (e.g., a dialkylaminobenzoic ester) or a phosphine-series photopolymerization accelerator.

The curable composition for forming the adhesive layer may further contain a cellulose derivative (for example, a cellulose ester, a cellulose carbamate, and a cellulose ether). The cellulose ester may include, for example, an aliphatic acyl ester (for example, a cellulose C₁₋₆ alkylcarbonyl ester, e.g., a cellulose acetate such as a cellulose diacetate or a cellulose triacetate; a cellulose C₂₋₆ alkylcarbonyl ester such as a cellulose propionate or a cellulose butyrate; and a cellulose acetate C₂₋₆ alkylcarbonyl ester such as a cellulose acetate propionate or a cellulose acetate butyrate), an aromatic acyl ester (for example, a cellulose C₇₋₁₂ arylcarbonyl ester such as a cellulose phthalate or a cellulose benzoate; and a cellulose acetate C₇₋₁₂ arylcarbonyl ester such as a cellulose acetate phthalate), and an ester of an inorganic acid (for example, a cellulose phosphate and a cellulose sulfate). The cellulose ester may be a mixed acid ester of a cellulose such as a cellulose acetate nitrate. The cellulose ester may be a C₁₋₆ alkylcarbonyl ester of an alkyl cellulose, such as an acetylalkyl cellulose. The cellulose derivative may also include a cellulose carbamate (e.g. a cellulose phenylcarbamate), a cellulose ether (e.g., a cyanoethylcellulose; a hydroxyC₂₋₄alkyl cellulose such as a hydroxyethyl cellulose or a hydroxypropyl cellulose; a C₁₋₆alkyl cellulose such as a methyl cellulose or an ethyl cellulose; a carboxymethyl cellulose or a salt thereof, and a benzyl cellulose). These cellulose derivatives may be used alone or in combination. Incidentally, a cellulose derivative soluble in an organic solvent (in particular, a co-solvent dissolving the above-mentioned polymerizable component) is used as the cellulose derivative. The cellulose derivative (e.g., the cellulose ester) not only is highly compatible with the curable component (e.g., the first curable component) but also improves the coatability, thereby enabling formation of a uniform coating layer.

The preferred cellulose derivative includes a cellulose ester, particularly a cellulose C₁₋₆alkyl carbonyl ester such as a cellulose acetate propionate.

The cellulose derivative content may be selected from the range that the adhesive layer does not deteriorate in functions and decrease in transparency, for example, the range of about 0.1 to 25 parts by weight relative to 100 parts by weight of the total amount of the first and second curable components. The cellulose derivative content may be about 0.5 to 10 parts by weight, preferably about 1 to 7 parts by weight, and more preferably about 2 to 5 parts by weight relative to 100 parts by weight of the total amount of the first and second curable components.

The adhesive layer may contain a conventional additive, for example, a plasticizer, a coloring agent, a dispersing agent, a mold-release agent (a releasing agent), a stabilizer (e.g., an antioxidant, an ultra violet ray absorbing agent, and a heat stabilizer), an antistatic agent, a flame retardant, and an antiblocking agent. These additives may be used alone or in combination.

The thickness of the adhesive layer may be, for example, selected from the range of about 0.1 to 50 μm, and may usually be about 1 to 35 μm, preferably about 5 to 30 μm, and more preferably about 10 to 25 μm. Incidentally, the adhesive layer formed by the cured layer of the curable composition has a high adhesiveness and a high transparency even when the adhesive layer is thick. Therefore, an anti-glare film having an excellent anti-glareness can be obtained without deterioration of optical properties.

[Anti-Glare Layer]

According to the present invention, the anti-glare layer is formed by a cured layer of a curable resin composition which contains a plurality of components being capable of phase separation and containing at least one curable component. Therefore, the anti-glare layer has a high abrasion resistance (hardcoat property).

The curable resin composition for forming the anti-glare layer contains a plurality of components being phase-separable and curable, and at least one of the plurality of components comprises a curable component. The curable component may be a thermosetting component or an active energy ray-curable component. Moreover, the curable component may be a monomer or an oligomer. The preferred curable component includes an active energy ray-curable component which can fix (or immobilize) a phase separation structure easily. Further, the preferred curable component contains at least a curable resin precursor. The precursor can be cured (or hardened) or crosslinked to form a resin (for example, a hard and tough resin such as a crosslinked resin). The curable resin composition usually contains at least one curable resin precursor (a curable resin precursor having a plurality of photopolymerizable groups (particularly, an active (or actinic) energy ray-curable resin precursor)) and at least one polymer component (one or more polymer component(s)). Moreover, at least one polymer component may have a reactive group to the curable resin precursor, at a main chain or side chain thereof.

(1) Curable Resin Precursor

The curable resin precursor as a curable component is a compound having a functional group reacting on heat or an active energy ray (e.g., an ultra violet ray or an electron beam) and forms a resin (particularly a cured or crosslinked resin) by heat or an active energy ray.

The resin precursor may include, for example, a thermosetting compound or resin [for example, a low molecular weight compound (or a prepolymer) having a condensable or reactive functional group and/or a polymerizable group] and a photo-curable compound curable by an active ray such as ultra violet ray (e.g., an ultra violet-curable compound such as a photo-curable monomer, oligomer, or prepolymer). The condensable or reactive functional group may include, for example, an epoxy group or glycidyl group, an isocyanate group, a hydroxyl group, a carboxyl group, an acid anhydride group, an amino group or imino group, an alkoxysilyl group, and a silanol group. The polymerizable group may include, for example, a C₂₋₆ alkenyl group such as vinyl, propenyl, isopropenyl, butenyl, or allyl group, a C₂₋₆ alkynyl group such as ethynyl, propynyl, or butynyl, a C₂₋₆ alkenylidene group such as vinylidene, and a (meth)acryloyl group. The low molecular weight compound may include, for example, a low molecular weight resin such as an epoxy-series resin, an unsaturated polyester-series resin, a urethane-series resin (e.g., a polyurethane oligomer having an isocyanate group at a terminal thereof), or a silicone-series resin)]. The photo-curable compound may be an EB (electron beam)-curable compound, and the like. Incidentally, the photo-curable compound (for example, a photo-curable monomer or oligomer, or a photo-curable resin which may have a low molecular weight) may simply be referred to as “photo-curable resin”. The curable resin precursors may be used alone or in combination.

The photo-curable compound usually has a photo-curable group, for example, a polymerizable group (e.g., a C₂₋₃ alkenyl group such as vinyl, propenyl, or isopropenyl group, and a (meth)acryloyl group) or a photosensitive group (e.g., cinnamoyl group). In particular, a photo-curable compound having a polymerizable group (for example, a monomer, an oligomer (or a low molecular weight resin)) is preferred as the photo-curable compound. These photo-curable compounds may be used alone or in combination.

The curable component may include the same monomer, oligomer or resin as the curable component described in the paragraph of the adhesive layer, for example, a monofunctional monomer [e.g., a C₁₋₁₆alkyl (meth)acrylate, a (meth)acrylate having an alicyclic hydrocarbon ring, and a (meth)acrylate having a crosslinked cyclic hydrocarbon ring], a glycidyl (meth)acrylate, a hydroxyalkyl (meth)acrylate; and a vinyl-series monomer], a polyfunctional monomer having at least two polymerizable unsaturated bonds [e.g., an alkylene glycol di(meth)acrylate; a (poly)alkylene glycol di(meth)acrylate; a di(meth)acrylate having an alicyclic hydrocarbon ring; a di(meth)acrylate having a crosslinked cyclic hydrocarbon ring; and a polyfunctional monomer having about 3 to 6 polymerizable unsaturated bonds], and an oligomer or a resin [e.g., an epoxy (meth)acrylate and a (poly)urethane (meth)acrylate].

The preferred curable resin precursor includes a photo-curable component curable in a short time, for example, an ultra violet-curable component (e.g., a monomer, an oligomer, and a low molecular weight resin) and an EB-curable compound. Further, to improve resistance such as abrasion or scratch resistance, the photo-curable component preferably includes an active energy ray-curable resin precursor having a plurality of photopolymerizable groups, for example, a monomer having a plurality (preferably about 2 to 10, more preferably about 2 to 6, and particularly about 3 to 6) of polymerizable unsaturated bonds (e.g., (meth) acryloyl group) per molecule, such as a polyfunctional (meth)acrylate. Incidentally, a compound having an acryloyl group is preferable as the photo-curable component.

In order to improve the hardness of the anti-glare layer, the curable component (or curable resin precursor) practically includes a tri- to hexa(meth)acrylate such as trimethylolpropane tri(meth)acrylate, 1,1,1-tri(2-hydroxyethoxymethyl)propane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, and dipentaerythritol hexa(meth)acrylate. These polyfunctional (meth)acrylates may be used alone or in combination. If necessary, the tri- to hexafunctional (meth)acrylate may be used in combination with a mono- or di(meth)acrylate having an alicyclic hydrocarbon ring or a crosslinked cyclic hydrocarbon ring.

As same as in the curable composition for forming the adhesive layer, the curable resin precursor may contain a curing agent (e.g., a photopolymerization initiator), a curing accelerator, a crosslinking agent, and a thermal-polymerization inhibitor, depending on the species of the curable component. The photopolymerization initiator as exemplified above may be used as the photopolymerization initiator in the same proportion as described above.

(2) Polymer Component

A thermoplastic resin may be usually employed as the polymer component. The thermoplastic resin may include a styrenic resin, a (meth)acrylic resin, an organic acid vinyl ester-series resin, a vinyl ether-series resin, a halogen-containing resin, an olefinic resin (including a cycloolefinic resin), a polycarbonate-series resin, a polyester-series resin, a polyamide-series resin, a thermoplastic polyurethane resin, a polysulfone-series resin (e.g., a polyether sulfone, and a polysulfone), a polyphenylene ether-series resin (e.g., a polymer of 2,6-xylenol), a cellulose derivative (e.g., a cellulose ester, a cellulose carbamate, and a cellulose ether), a silicone resin (e.g., a polydimethylsiloxane, and a polymethylphenylsiloxane), a rubber or elastomer (e.g., a diene-series rubber such as a polybutadiene or a polyisoprene, a styrene-butadiene copolymer, an acrylonitrile-butadiene copolymer, an acrylic rubber, a urethane rubber, and a silicone rubber), and the like. These polymer components may be used alone or in combination.

The styrenic resin may include a homo- or copolymer of a styrenic monomer (e.g., styrene, α-methylstyrene, and vinyltoluene) such as a polystyrene, a copolymer of a styrenic monomer and another polymerizable monomer [e.g., a (meth)acrylic monomer, maleic anhydride, a maleimide-series monomer, and a diene], and other polymers. The styrenic copolymer may include, for example, a styrene-acrylonitrile copolymer (AS resin), a styrene-methyl methacrylate copolymer, a styrene-methyl methacrylate-(meth)acrylate copolymer, a styrene-methyl methacrylate-(meth)acrylic acid copolymer, and a styrene-maleic anhydride copolymer. The preferred styrenic resin includes a polystyrene, a copolymer of styrene and a (meth)acrylic monomer [e.g., a copolymer comprising styrene and methyl methacrylate as main components], an AS resin, a styrene-butadiene copolymer, and the like.

The (meth)acrylic resin may include a homo- or copolymer of a (meth)acrylic monomer, a copolymer of a (meth)acrylic monomer and a copolymerizable monomer, and other polymers. The (meth)acrylic monomer may include, for example, (meth)acrylic acid; a C₁₋₁₀alkyl (meth)acrylate such as methyl (meth)acrylate, ethyl (meth)acrylate, butyl (meth)acrylate, hexyl (meth)acrylate, or 2-ethylhexyl (meth)acrylate; a cycloalkyl (meth)acrylate such as cyclohexyl (meth)acrylate; an aryl (meth)acrylate such as phenyl (meth)acrylate; a hydroxyalkyl (meth)acrylate such as hydroxyethyl (meth)acrylate or hydroxypropyl (meth)acrylate; glycidyl (meth)acrylate; an N,N-dialkylaminoalkyl (meth)acrylate; (meth)acrylonitrile, a (meth)acrylate having a crosslinked cyclic hydrocarbon group such as tricyclodecane. The copolymerizable monomer may include the above styrenic monomer, a vinyl ester-series monomer, maleic anhydride, maleic acid, and fumaric acid. These monomers may be used alone or in combination.

The (meth)acrylic resin may include, for example, a poly(C₁₋₆alkyl (meth)acrylate) such as a poly(methyl methacrylate), a methyl methacrylate-(meth)acrylic acid copolymer, a methyl methacrylate-(meth)acrylate copolymer, a methyl methacrylate-acrylate-(meth)acrylic acid copolymer, and a (meth)acrylate-styrene copolymer (e.g., an MS resin). The preferred (meth)acrylic resin includes a methyl methacrylate-series resin containing methyl methacrylate as a main component (about 50 to 100% by weight, and preferably about 70 to 100% by weight).

The organic acid vinyl ester-series resin may include a homo- or copolymer of a vinyl ester-series monomer (e.g., a polyvinyl acetate), a copolymer of a vinyl ester-series monomer and a copolymerizable monomer (e.g., an ethylene-vinyl acetate copolymer, a vinyl acetate-vinyl chloride copolymer, and a vinyl acetate-(meth)acrylate copolymer), or a derivative thereof (e.g., a polyvinyl alcohol, an ethylene-vinyl alcohol copolymer, and a polyvinyl acetal resin).

The vinyl ether-series resin may include a homo- or copolymer of a vinyl C₁₋₁₀alkyl ether such as vinyl methyl ether or vinyl ethyl ether, and a copolymer of a vinyl alkyl ether and a copolymerizable monomer, such as a vinyl alkyl ether-maleic anhydride copolymer. The halogen-containing resin may include a polyvinyl chloride, a polyvinylidene fluoride, a vinyl chloride-vinyl acetate copolymer, a vinyl chloride-(meth)acrylate copolymer, a vinylidene chloride-(meth)acrylate copolymer, and the like.

The olefinic resin may include, for example, an olefinic homopolymer such as a polyethylene or a polypropylene, and a copolymer such as an ethylene-vinyl acetate copolymer, an ethylene-(meth)acrylic acid copolymer, or an ethylene-(meth)acrylate copolymer. The cycloolefinic resin may include a cycloolefinic polymer as exemplified above, and other polymers.

The polycarbonate-series resin may include an aromatic polycarbonate based on a bisphenol (e.g., bisphenol A), an aliphatic polycarbonate such as diethylene glycol bisallyl carbonate, and others.

The polyester-series resin may include an aromatic polyester [for example, a poly(alkylene arylate) including a poly(C₂₋₄ alkylene arylate) such as a poly(C₂₋₄ alkylene terephthalate) or a poly(C₂₋₄ alkylene naphthalate) (e.g., a poly(ethylene terephthalate) and a poly(butylene terephthalate), and a copolyester containing a C₂₋₄ alkylene arylate unit as a main component (e.g., in a proportion of not less than 50% by weight)]. The copolyester may include a copolyester in which part of C₂₋₄ alkylene glycols is substituted (or replaced) with a poly(oxyC₂₋₄ alkylene glycol), a C₆₋₁₀ alkylene glycol, a cyclic diol (e.g., cyclohexane dimethanol and hydrogenated bisphenol A), a diol having an aromatic ring (e.g., 9,9-bis(4-(2-hydroxyethoxy)phenyl)fluorene, a bisphenol A, a bisphenol A-alkylene oxide adduct, or the like), and a copolyester in which part of aromatic dicarboxylic acids is substituted (or replaced) with an unsymmetric aromatic dicarboxylic acid such as phthalic acid or isophthalic acid, an aliphatic C₆₋₁₂ dicarboxylic acid such as adipic acid, or the like. The polyester-series resin may also include a polyarylate-series resin, an aliphatic polyester obtain able from an aliphatic dicarboxylic acid such as adipic acid, and a homo- or copolymer of a lactone such as ε-caprolactone. The preferred polyester-series resin is usually a non-crystalline resin, such as a non-crystalline copolyester (e.g., a C₂₋₄ alkylene arylate-series copolyester).

The polyamide-series resin may include a polyamide obtain able from a polyamide component [for example, a dicarboxylic acid (e.g., terephthalic acid, isophthalic acid, and adipic acid), a diamine (e.g., hexamethylenediamine and metaxylylenediamine), and a lactam (e.g., ε-caprolactam)], for example, an aliphatic polyamide, an alicyclic polyamide, and an aromatic polyamide. The polyamide is not limited to a homopolyamide and may be a copolyamide. The representative polyamide-series resin includes, for example, a nylon 46, a nylon 6, a nylon 66, a nylon 610, a nylon 612, a nylon 11, or a nylon 12.

Among the cellulose derivatives, the cellulose ester may include, as same as in the above-mentioned the cellulose ester, an aliphatic acyl ester of a cellulose (for example, a C₁₋₆ alkylcarbonyl ester of a cellulose, e.g., a cellulose acetate, a cellulose C₂₋₆alkyl-carbonyl ester, a cellulose acetate C₂₋₆alkyl-carbonyl ester; a C₁₋₆ alkylcarbonyl ester of an alkyl cellulose, such as an acetylalkyl cellulose), an aromatic acyl ester of a cellulose (e.g., a cellulose C₇₋₁₂ arylcarbonyl ester such as a cellulose phthalate or a cellulose benzoate), and an inorganic acid ester of a cellulose. The cellulose derivative may also include a cellulose carbamate, a cellulose ether (e.g., a cyanoethyl cellulose; a hydroxyC₂₋₄alkyl cellulose; a C₁₋₆alkyl cellulose; a carboxymethyl cellulose or a salt thereof, and a benzyl cellulose).

The preferred thermoplastic resin includes, for example, a resin having excellent moldability or film-forming (film-formable) properties, transparency, and weather resistance, and for example, a styrenic resin, a (meth)acrylic resin, a cycloolefinic resin, a polyester-series resin, and a cellulose derivative (e.g., a cellulose ester). The thermoplastic resin to be usually employed includes a resin that is non-crystalline and is soluble in an organic solvent (particularly a common solvent for dissolving a plurality of polymers and curable compounds).

The polymer component may comprise a plurality of polymers in a suitable combination. The plurality of polymer components may be phase-separable (in the absence of a solvent), or may be phase-separable in a liquid phase before complete evaporation of a solvent. Moreover, the plurality of polymer components may be incompatible with each other. In the case of combining the plurality of polymers, the combination of a first polymer with a second polymer is not particularly limited to a specific one and may be a suitable combination such as a combination of a plurality of polymers incompatible with each other around a processing temperature, for example, a combination of two polymer components incompatible with each other. For example, in the case where the first polymer component is a styrenic resin (e.g., a polystyrene, and a styrene-acrylonitrile copolymer), the second polymer component may be a cellulose derivative (e.g., a cellulose ester such as a cellulose acetate propionate), a (meth)acrylic resin (e.g., a poly(methyl methacrylate)), a cycloolefinic resin (e.g., a polymer obtained with norbornene as a monomer), a polycarbonate-series resin, a polyester-series resin (e.g., the above-mentioned poly(C₂₋₄ alkylene arylate)-series copolyester), and others. Moreover, for example, when the first polymer component is a cellulose derivative (e.g., a cellulose ester such as a cellulose acetate propionate), the second polymer component may be a styrenic resin (e.g., a polystyrene, and a styrene-acrylonitrile copolymer), a (meth)acrylic resin, a cycloolefinic resin (e.g., a polymer obtained with norbornene as a monomer), a polycarbonate-series resin, a polyester-series resin (e.g., the above-mentioned poly(C₂₋₄ alkylene arylate)-series copolyester), and others.

In particular, it is preferable to use at least cellulose derivative (e.g., a cellulose ester) as the polymer component of the resin composition (or in a combination of a plurality of polymer components) of the present invention. The cellulose derivative (e.g., a cellulose ester) is a semisynthetic polymer and is different in dissolution behavior from other resins or a curable resin precursor. Therefore, a resin composition containing the cellulose derivative has very good phase separability. Among them, it is preferable to use at least a cellulose ester [for example, a cellulose acetate (e.g., a cellulose diacetate and a cellulose triacetate), a cellulose C₂₋₄ alkylcarbonyl ester (e.g., a cellulose acetate propionate and a cellulose acetate butyrate)].

A polymer component (or thermoplastic resin) having a functional group participating in a curing reaction (or a functional group capable of reacting with the curable precursor) at a main chain thereof or at a side chain thereof may be used as the above-mentioned polymer component. The functional group may be introduced into the main chain of the polymer component by co-polymerization, co-condensation or the like and is usually introduced into the side chain of the polymer component. In view of abrasion or scratch resistance of the cured anti-glare layer, it is preferable that at least one of the plurality of polymer components be a polymer component having a functional group reactive to the curable resin precursor at a side chain thereof. Such a functional group may include a group exemplified as the condensable or reactive functional group or polymerizable functional group of the resin precursor. Among these functional groups, the polymerizable group [for example, a C₂₋₃ alkenyl group (e.g., vinyl group, propenyl group, and isopropenyl group) and (meth)acryloyl group, particularly, (meth)acryloyl group] is preferred. The polymer component having such a functional group may be cured or crosslinked in the anti-glare layer along with curing or crosslinking of the curable resin precursor.

The thermoplastic resin having a polymerizable group at the side chain may be for example, produced by allowing (i) a thermoplastic resin having a reactive group (e.g., the condensable or reactive functional group as exemplified above) to react with (ii) a polymerizable compound having a group (reactive group) reactive to the reactive group of the thermoplastic resin to introduce the polymerizable functional group of the compound (ii) into the thermoplastic resin.

Examples of the thermoplastic resin (i) having the reactive group may include a thermoplastic resin having a carboxyl group or an acid anhydride group thereof [for example, a (meth)acrylic resin comprising (meth)acrylic acid as an essential component (e.g., a (meth)acrylic acid-(meth)acrylate copolymer and a methyl methacrylate-acrylate-(meth)acrylic acid copolymer) and a polyester-series resin or polyamide-series resin having a terminal carboxyl group]; a thermoplastic resin having a hydroxyl group [for example, a (meth)acrylic resin (e.g., a (meth)acrylate-hydroxyalkyl (meth)acrylate copolymer), a polyester-series resin or polyurethane-series resin having a terminal hydroxyl group, a cellulose derivative (e.g., a hydroxyC₂₋₄alkyl cellulose such as a hydroxyethyl cellulose or a hydroxypropyl cellulose), and a polyamide-series resin (e.g., an N-methylolacrylamide copolymer)]; a thermoplastic resin having an amino group (e.g., a polyamide-series resin having a terminal amino group); and a thermoplastic resin having an epoxy group [e.g., a (meth)acrylic resin or polyester-series resin having an epoxy group (such as a glycidyl group)]. Moreover, as the thermoplastic resin (i) having the reactive group, there may be used a resin obtained by introducing the reactive group into a thermoplastic resin (e.g., a styrenic resin or an olefinic resin, and a cycloolefinic resin) by co-polymerization or graft polymerization. Among these thermoplastic resins (i), the preferred thermoplastic resin has a carboxyl group or an acid anhydride group thereof, a hydroxyl group or a glycidyl group (particularly a carboxyl group or an acid anhydride group thereof), as a reactive group. Incidentally, among the (meth)acrylic resins, the copolymer is preferably produced using monomer(s) containing (meth)acrylic acid at a proportion of not less than 50 mol %. These thermoplastic resins (i) may be used alone or in combination.

The reactive group of the polymerizable compound (ii) may include a group reactive to the reactive group of the thermoplastic resin (i) and, for example, may include a functional group similar to the condensable or reactive functional group exemplified in the paragraph (or item) of the functional group of the polymer mentioned above.

Examples of the polymerizable compound (ii) may include a polymerizable compound having an epoxy group [e.g. an epoxy group-containing (meth)acrylate (an epoxyC₃₋₈alkyl (meth)acrylate such as glycidyl (meth)acrylate or 1,2-epoxybutyl (meth)acrylate; an epoxyC₅₋₈ cycloalkenyl (meth)acrylate such as epoxycyclohexenyl (meth)acrylate), and allyl glycidyl ether], a compound having a hydroxyl group [for example, a hydroxyl group-containing (meth)acrylate, e.g., a hydroxyC₂₋₆alkyl (meth)acrylate such as hydroxypropyl (meth)acrylate], a polymerizable compound having an amino group [e.g., an amino group-containing (meth)acrylate (such as a C₃₋₆ alkenylamine such as allylamine); and an aminostyrene such as 4-aminostyrene or diaminostyrene], a polymerizable compound having an isocyanate group [e.g., a (poly)urethane (meth)acrylate and vinylisocyanate], and a polymerizable compound having a carboxyl group or an acid anhydride group thereof [e.g., an unsaturated carboxylic acid or an anhydride thereof, such as (meth)acrylic acid or maleic anhydride]. These polymerizable compounds (ii) may be used alone or in combination.

The functional group-containing polymer component, e.g., a polymer in which a polymerizable unsaturated group is introduced using part of carboxyl groups of a (meth)acrylic resin, is, for example, available as “CYCLOMER-P” from Daicel Chemical Industries, Ltd. Incidentally, “CYCLOMER-P” is a (meth)acrylic polymer in which epoxy group(s) of 3,4-epoxycyclohexenylmethyl acrylate is allowed to react with part of carboxyl groups in a (meth)acrylic acid-(meth)acrylate copolymer for introducing photo-polymerizable unsaturated group(s) at the side chain.

The amount of the functional group (particularly the polymerizable group) to be introduced into the polymer component (the thermoplastic resin) is about 0.001 to 10 mol, preferably about 0.01 to 5 mol, and more preferably about 0.02 to 3 mol relative to 1 kg of the thermoplastic resin.

The glass transition temperature of the polymer component may, for example, be selected from the range of about −100° C. to 250° C., preferably about −50° C. to 230° C., and more preferably about 0° C. to 200° C. (for example, about 50° C. to 180° C.). In view of surface hardness, it is advantageous that the glass transition temperature is not lower than 50° C. (e.g., about 70° C. to 200° C.) and preferably not lower than 100° C. (e.g., about 100° C. to 170° C.). The weight-average molecular weight of the polymer component may, for example, be selected within the range of not more than 100×10⁴ and preferably about 0.1×10⁴ to 50×10⁴, and may usually be about 0.5×10⁴ to 50×10⁴, preferably about 1×10⁴ to 25×10⁴, and more preferably about 2×10⁴ to 10×10⁴.

The resin composition contains at least one polymer component (a cellulose derivative such as a cellulose ester).

When the resin composition comprises a plurality of polymer components, the ratio (weight ratio) of the first polymer component relative to the second polymer component [the former/the latter] may be selected from the range of, for example, about 1/99 to 99/1, preferably about 5/95 to 95/5, and more preferably about 10/90 to 90/10 and is usually about 20/80 to 80/20. In particular, in the case where the first polymer comprises a cellulose derivative, the ratio (weight ratio) of the first polymer relative to the second polymer [the former/the latter] may be, for example, about 1/99 to 50/50, preferably about 5/95 to 40/60, and more preferably about 10/90 to 35/65 (e.g., about 15/85 to 25/75) and is usually about 15/80 to 30/70.

Incidentally, the resin composition may comprise the above-mentioned thermoplastic resin or other polymer components in addition to the two polymer components incompatible with each other.

The proportion of the curable resin precursor in the curable resin composition may be selected from the range that allows a highly hard anti-glare layer to be formed without inhibition of the formation of the phase separation structure. For example, the proportion of the curable resin precursor in the total amount of the curable resin precursor and the polymer component may be, in terms of solid contents, selected from the range of about 30 to 95% by weight (e.g., about 50 to 90% by weight) and may usually be, in terms of solid contents, not less than 60% by weight, for example, about 60 to 95% by weight, preferably about 63 to 90% by weight, and more preferably about 65 to 85% by weight. The ratio (weight ratio) of the polymer component relative to the curable resin precursor [the former/the latter] may be, for example, selected from the range of about 5/95 to 95/5, and in view of surface hardness, is preferably about 5/95 to 50/50, more preferably about 5/95 to 40/60 (e.g., about 10/90 to 40/60), and particularly about 5/95 to 30/70.

(3) Additive

If necessary, to the curable resin composition (or anti-glare layer) of the present invention may be added an additive component. Examples of the additive component may include a leveling agent, a stain-proofing agent, a slip-improving agent, a wettability-improving agent, and an antistatic agent. The proportion of the additive is about 0.05 to 5% by weight and preferably about 0.1 to 3% by weight in the total components contained in the anti-glare layer.

The leveling agent may include a silicone-series compound, a fluorine-containing compound, and others. Some of these leveling agents have characteristics of both a leveling agent and a stain-proofing agent or a slip-improving agent. These additives are preferably localized near the outermost surface of the anti-glare layer. Moreover, regarding the reactivity with the curable resin precursor, the leveling agent may or may not have the reactivity to the curable resin precursor. In view of the durability of the effects, it is preferable that the leveling agent exist as part of the cured or crosslinked resin by allowing the leveling agent to react with the curable resin precursor. The additive having a reactive functional group may include, for example, a silicone-containing compound having a polymerizable unsaturated group (manufactured by DAICEL-CYTEC Company, Ltd., “EB1360”) and a fluorine-containing compound having a polymerizable unsaturated group (manufactured by OMNOVA SOLUTIONS Inc., “POLYFOX3320”). These components may be used alone or in combination.

Further, the anti-glare layer may contain a conventional additive, for example, a plasticizer, a coloring agent, a dispersing agent, a mold-release agent (a releasing agent), a stabilizer (e.g., an antioxidant, an ultra violet ray absorbing agent, and a heat stabilizer), an antistatic agent, a flame retardant, and an antiblocking agent. These additives may also be used alone or in combination.

Incidentally, these additives may be contained in the anti-glare layer having an uneven surface. As described later, when a low-reflection layer is further formed on the outermost layer, these additives may be contained in the low-reflection layer.

(4) Phase Separation

The anti-glare layer is formed with the cured (or hardened) resin composition and has a phase separation structure. The phase separation structure can be formed by phase separation of at least two components among at least one of the above curable resin precursor and at least one polymer component (by phase separation from a liquid phase containing these components) in a coated layer system. The phase separation is usually formed around a processing temperature (coat-forming or film-forming temperature). A combination of these phase-separable components may include, for example, (a) a combination in which a plurality of polymer components are incompatible with each other and form a phase separation, (b) a combination in which a curable resin precursor and one or a plurality of polymer component(s) are incompatible with each other and form a phase separation, and (c) a combination in which a plurality of curable resin precursors are incompatible with each other and form a phase separation. For the phase separation, (a) the combination of the plurality of polymer components or (b) the combination of the curable resin precursor and the polymer component(s) is usually employed. In particular, (a) the combination of the plurality of polymer components is preferred. Incidentally, when the plurality of polymer components is used, the curable resin precursor may be compatible with at least one polymer component.

For example, in the combination (a), when the plurality of polymers incompatible with each other comprises, for example, a first polymer and a second polymer, the curable resin precursor may be compatible with at least one polymer component of the first and second polymers or compatible with both polymer components. In the case where the curable resin precursor is compatible with both polymer components, the phase separation comprises at least two phases separation in which one phase comprises a mixture containing the first polymer and the curable resin precursor as main components, and the other phase comprises a mixture containing the second polymer and the curable resin precursor as main components. In the combination (b) a plurality of polymer components as the polymer component may be used. When the plurality of polymer components is used, it is sufficient that at least one polymer component is incompatible with the curable resin precursor. The other polymer components may be compatible with the resin precursor. Further, in the combination (b), the curable resin precursor may be compatible with at least one polymer component among the incompatible polymer components.

Incidentally, the phase separability can be conveniently evaluated as follows: a good solvent for each component (the curable resin precursor and the polymer component(s)) is used to prepare a uniform solution, and whether the residual solid matter becomes clouded or not in the step for gradual evaporation of the solvent is visually conformed.

Further, the phase-separated resin components in the cured or crosslinked anti-glare layer are usually different from each other in refraction index. For example, the polymer component and the cured or crosslinked resin obtained by curing the resin precursor are different from each other in refraction index. Moreover, the plurality of polymer components (the first polymer and the second polymer) is also different from each other in refraction index. According to the present invention, the difference in refraction index between the phase-separated resin components (the difference in refraction index between the polymer component and the cured or crosslinked resin obtained from the resin precursor, the difference in refraction index between the plurality of polymer components (the first polymer and the second polymer)) may be, for example, about 0 to 0.06, preferably about 0.0001 to 0.05, and more preferably about 0.001 to 0.04. The selection of the polymer component and the curable resin precursor satisfying such a difference in refraction index allows a difference in refraction index between the phase-separated domains to be similar to that between the materials. In particular, internal scattering from the domains is prevented or suppressed to the internal haze, and a black display image can be realized.

According to the present invention, the phase separation inside of the anti-glare layer is accompanied by the formation of an uneven (or finely uneven) surface structure (a surface structure having a raised portion and an indentation portion) of the anti-glare layer, and the curing of the curable resin precursor immobilizes (or fixes) the phase separation structure, whereby the anti-glare layer can be formed as a hardcoat layer. That is, the uneven surface structure (the uneven surface having projections (or protrusions) due to the internal phase-separation structure) is finally cured (or hardened) by an active (or actinic) ray (e.g., an ultra violet ray and an electron beam), a thermic ray, or others so that a cured resin immobilizing phase separation structure is formed. Accordingly, the cured resin can impart abrasion or scratch resistance (hardcoat property) to the anti-glare layer (hardcoat layer) and can improve durability of the anti-glare film.

The thickness of the anti-glare layer may be, for example, about 0.3 to 50 μm (e.g., about 1 to 40 μm) and preferably about 5 to 30 μm and is usually about 7 to 25 μm (e.g., about 10 to 20 μm).

[Process for Producing Anti-Glare Film]

The anti-glare film can be produced by (i) a step for applying the first liquid coating composition for forming the adhesive layer on the surface of the substrate film, (ii) a step for applying the second liquid coating composition on the coated surface, the second liquid coating composition comprising the curable resin composition containing the solvent and the plurality of components capable of phase separation, and at least one of the plurality of components containing a curable component, (iii) a step for forming a phase separation structure by phase separation with evaporating the solvent, and (iv) a step for curing (or hardening) the resin precursor(s) of each composition. The resulting anti-glare layer has the phase separation structure and the uneven surface structure and is adhered to the substrate film through the adhesive layer. Incidentally, according to the present invention, use of the first liquid coating composition can form the coated layer having a high adhesiveness in spite of applying the first liquid coating composition on the surface of the substrate film and the second liquid coating composition on the coated surface without any surface treatment of the substrate film. Moreover, after forming the adhesive layer by applying the first liquid coating composition on the surface of the substrate film and curing the curable component, the anti-glare layer may be formed by applying the second liquid coating composition on the cured adhesive layer and curing the curable component. The adhesive layer and the anti-glare layer may be formed by applying the first liquid coating composition and the second liquid coating composition on the surface of the substrate film in this order and curing the curable component. In the case of the sequential applying of the first and second liquid coating compositions, the second liquid coating composition may be applied without drying or after drying the first liquid coating composition.

Regarding the first liquid coating composition, the curable composition containing at least the first curable component (e.g., tricyclodecanedimethaol di(meth)acrylate) may be used as the first liquid coating composition. A coating agent containing the curable composition and the solvent dissolving the components of the curable composition (for example, a coating agent containing at least the first curable component, the cellulose derivative, the photopolymerization initiator, the solvent dissolving these components) may be used as the first liquid coating composition. Incidentally, the solvent may include, for example, a ketone (e.g., acetone, methyl ethyl ketone, methyl isobutyl ketone, acetylacetone, an acetoacetic ester, and cyclohexanone), an ether (e.g., diethyl ether, dioxane, and tetra hydrofuran), an ester (e.g., methyl acetate, ethyl acetate, and butyl acetate), an aliphatic hydrocarbon (e.g., hexane), an alicyclic hydrocarbon (e.g., cyclohexane), an aromatic hydrocarbon (e.g., toluene and xylene), a halogenated hydrocarbon (e.g., dichloromethane and dichloroethane), water, an alcohol (e.g., methanol, ethanol, propanol, isopropanol, 1-methoxy-2-propanol, butanol, t-butanol, cyclohexanol, diacetone alcohol, furfuryl alcohol, tetra hydrofurfuryl alcohol, ethylene glycol, propylene glycol, and hexylene glycol), a cellosolve (e.g., methyl cellosolve, ethyl cellosolve, and butyl cellosolve), a carbitol (e.g., diethylene glycol monomethyl ether and diethylene glycol monoethyl ether), a (di)propylene glycol monoalkyl ether corresponding to the cellosolve or carbitol (e.g., propylene glycol monomethyl ether), a cellosolve acetate, a sulfoxide (e.g., dimethyl sulfoxide), and an amide (e.g., dimethylformamide and dimethyhlacetamide). These solvents may be used alone or in combination.

A liquid coating composition which contains the curable resin precursor having a plurality of photopolymerizable groups, at least one polymer component, and the solvent (particularly, a liquid coating composition containing the polyfunctional (meth)acrylate having a plurality of (meth)acryloyl groups, the cellulose derivative, the polymer component having a (meth)acryloyl group, the photopolymerization initiator, the solvent dissolving the polyfunctional (meth)acrylate polymer component and the photopolymerization initiator) is practically used as the second liquid coating composition. The phase separation can occur in the process of the evaporation of the solvent from a liquid phase (liquid composition) containing the curable resin composition and the solvent (a wet phase separation method).

In the wet phase separation method, the state of the wet phase separation system is a continuous nonequilibrium state, which changes every moment along with (or following) the evaporation of the solvent. Therefore, it is difficult to explain the formation of the structure in the phase separation process theoretically. However, the reference “Macromolecules, vol. 17, 2812 (1984)” discloses that a basic phase separation process in the presence of a solvent shows the same behavior as that shown in a phase separation theory of two kinds of polymers. That is, the wet phase separation method also probably has two phase separation modes, spinodal decomposition and nucleation. The phase separation due to the spinodal decomposition is characterized by forming a relatively regular (or equally spaced) phase separation structure due to generation of a uniform density-fluctuation in the whole system. On the other hand, the phase separation due to the nucleation produces inhomogeneous (or ununiform) density-fluctuation to form a random (or irregular) phase separation structure. The phase separation by the spinodal decomposition is preferred since the structure of the phase separation to be formed is regulated. A phase diagram represented by the formulation and the change of state (for example, temperature change, or solvent concentration in the wet phase separation method) shows which of the two modes generates the phase separation and proceeding. The phase separation by the spinodal decomposition usually has a wider expression region compared with the phase separation by the nucleation.

The density fluctuation generated in the phase separation by the spinodal decomposition forms the bicontinuous phase structure along with the progress of the phase separation. Further proceeding of the phase separation makes the continuous phase discontinuous owing to its own surface tension to change into the droplet phase structure (e.g., an islands-in-the-sea structure containing independent phases such as ball-like shape, spherical shape, discotic shape, oval-sphere shape, or rectangular prism shape). Therefore, an intermediate structure of the bicontinuous phase structure and the droplet phase structure (i.e., a phase structure in a transitional state from the bicontinuous phase to the droplet phase) can also be formed depending on the degree of phase separation. The phase-separation structure in the anti-glare layer according to the present invention may be an islands-in-the-sea structure (a droplet phase structure, or a phase structure in which one phase is independent or isolated) or a bicontinuous phase structure (or a mesh structure), or may be an intermediate structure being a coexistent state of a bicontinuous phase structure and a droplet phase structure. The phase-separation structure realizes the formation of a finely uneven (convex and concave) structure on the surface of the obtained anti-glare layer after drying of the solvent.

In the phase-separation structure, it is advantageous that the structure forms a droplet phase structure having at least an island domain in view of forming the uneven surface structure and of improving the surface hardness. Incidentally, when the phase-separation structure comprising the polymer component and the above-mentioned precursor (or cured resin) forms an islands-in-the-sea structure, the polymer component may form the sea phase. It is, however, advantageous in view of surface hardness that the polymer component forms island domains. The formation of the island domains realizes a finely uneven structure of the surface after drying the anti-glare layer. According to the present invention, the island domain may be a deformed (or irregular) shape (e.g., a long shape such as oval-sphere shape or rectangular prism shape). Moreover, the plane shape (or form) of the domain may be an amorphous form, a polygonal form, a circular form, an oval (or elliptical) form, and others. Further, these island domains may be independent from each other or may be partly united or bonded with each other to form a continuous domain. The mean distance between domains of the uneven surface structure [the pitch of the tops of the adjacent protruded regions (the pitch of the adjacent domains)] may be selected from the range of about 5 to 200 μm (e.g., about 10 to 175 μm) and, for example, may be about 10 to 150 μm and preferably about 15 to 100 μm. Moreover, the mean diameter of the domain may be, for example, about 3 to 100 μm, preferably about 5 to 50 μm, and more preferably about 8 to 30 μm (particularly about 10 to 25 μm).

For the wet phase separation, the solvent may be selected depending on the species and solubility of the curable resin precursor and polymer component. In the case of a mixed solvent, at least one solvent needs only to be a solvent uniformly dissolving a solid component(s) or nonvolatile matter (a curable resin precursor and a polymer component, a reaction initiator, other additive(s)). The solvent may include, the same solvent as the solvent for the first liquid coating composition, for example, a ketone (e.g., acetone, methyl ethyl ketone, and methyl isobutyl ketone), an ether, an ester (e.g., methyl acetate, ethyl acetate, and butyl acetate), an aliphatic hydrocarbon (e.g., hexane), an alicyclic hydrocarbon (e.g., cyclohexane), an aromatic hydrocarbon (e.g., toluene and xylene), a halogenated hydrocarbon, water, an alcohol (e.g., ethanol, propanol, isopropanol, 1-methoxy-2-propanol, butanol, t-butanol, and cyclohexanol), a cellosolve, a carbitol, a cellosolve acetate, a sulfoxide, and an amide. These solvents may be used alone or in combination. Incidentally, not only a low boiling point solvent (for example, acetone, methyl acetate, dichloromethane, methanol, ethanol, and isopropanol) but also a high boiling point solvent (for example, 1-methoxy-2-propanol and a cellosolve (ethyl cellosolve)) may be used as a solvent for dissolving the cellulose ester, depending on the species of the cellulose ester.

In the second liquid coating composition, the preferred solvent has a boiling point of not lower than 100° C. at an atmospheric pressure (which may be referred to as a high boiling point solvent). The boiling point of the high boiling point solvent (a solvent having a low vapor pressure) is not lower than 100° C. (usually about 100 to 200° C., preferably about 105 to 150° C., and more preferably about 110 to 130° C.). Further, in order to form the phase separation, the solvent preferably comprises a plurality of solvents having different boiling points (the high boiling point solvent and a low boiling point solvent having a boiling point lower than 100° C.). The boiling point of the low boiling point solvent (a solvent having a high vapor pressure) may be lower than 100° C. (for example, about 35 to 99° C., preferably about 40 to 95° C., and more preferably about 50 to 85° C.). The weight ratio of the high boiling point solvent relative to the low boiling point solvent [the former/the latter] may be selected, for example, from the range of about 5/95 to 90/10 (e.g., about 10/90 to 70/30). The weight ratio may usually be about 15/85 to 60/40 and preferably about 20/80 to 50/50 (particularly about 20/80 to 40/60).

The concentration of the solute (the curable resin precursor and the polymer component, the reaction initiator, and other additives) in the second liquid coating composition may be selected from the range that does not deteriorate the phase separability and the castability or coatability, and may be selected from, for example, the range of about 1 to 80% by weight and is usually about 5 to 70% by weight and preferably about 15 to 60% by weight.

After casting or applying the second liquid coating composition, the phase separation can be induced by evaporation of the solvent. Moreover, the phase separation (e.g., spinodal decomposition) accompanied by the evaporation of the solvent can provide regularity or periodicity to the mean distance between domains of the phase separation structure. The evaporation or removal temperature (drying temperature) of the solvent is not particularly limited to a specific one and may be lower than the boiling point of the solvent. For example, it is preferable that the difference between the boiling point of the solvent and the evaporation temperature (drying temperature) be selected from the range within 100° C., preferably within 70° C., and more preferably within 50° C. The evaporation or removal of the solvent may usually be carried out by drying, for example, drying at an temperature of about 30° C. to 150° C., preferably about 40° C. to 120° C., and more preferably about 50° C. to 90° C. depending on the boiling point of the solvent.

The adhesive layer and the anti-glare layer may be obtained by curing at least the above curable component (e.g., a curable resin precursor) of each coated layer with heat, an actinic ray, or the like. In a preferred embodiment, the photo-curable component of each coated layer is cured with a light irradiation. The light irradiation may be selected according to the kind of the photo-curable component or others, and an ultra violet ray or an electron beam may usually be available for the light irradiation. The general-purpose light source for exposure is usually an ultra violet irradiation equipment. If necessary, the light irradiation may be carried out under an inert gas atmosphere such as nitrogen gas or carbon dioxide. The curing of the curable component (e.g., the curable resin precursor) can form the adhesive layer tightly adhered or bonded to the substrate film and immobilize the phase separation structure of the anti-glare layer and can usually form the phase separation structure having a regular or periodic mean distance between the domains.

(5) Low-Refraction-Index Layer

The low-refraction-index layer may be laminated (or formed) on at least one side (or surface) of the anti-glare layer. When the low-refraction-index layer is disposed as an outermost layer of the anti-glare film for an optical member or the like, the reflection of a light [e.g., a light source around the optical member (such as an ambient light or an external light source)] from the surface of the anti-glare film can be effectively prevented. The refraction index of the low-refraction-index layer may be, for example, about 1.30 to 1.49, preferably about 1.30 to 1.45, and more preferably about 1.30 to 1.40.

The low-refraction-index layer comprises a low-refraction-index resin (or a resin having a low refraction index). The resin for the low-refraction-index layer may include, for example, a methylpentene resin, a (meth)acrylate resin, a diethylene glycol bis(allyl carbonate) resin, and a fluorine-containing resin such as a poly(vinylidene fluoride) (PVDF) or a poly(vinyl fluoride) (PVF). Moreover, it is usually preferable that the low-refraction-index layer contain a fluorine-containing compound. The fluorine-containing compound can desirably reduce the refraction index of the low-refraction-index layer. Further, the low-refraction-index layer may contain a hollow fine particle (for example, a metal oxide particle such as a silica particle). The mean diameter of the fine particle may be not larger than 100 nm (e.g., about 5 to 100 nm, preferably about 10 to 70 nm, and practically about 20 to 50 nm).

The fluorine-containing compound may include a fluorine-containing resin precursor which has a fluorine atom and a reactive functional group (e.g., a curable group such as a crosslinkable group or a polymerizable group) by heat or an actinic ray (e.g., an ultra violet ray or an electron beam) or the like and which can be cured or crosslinked by heat or an actinic ray or the like to form a fluorine-containing resin (particularly a cured or crosslinked resin). Examples of such a fluorine-containing resin precursor may include a fluorine atom-containing thermosetting compound or resin [a low molecular weight compound which has a fluorine atom, and a reactive group (e.g., an epoxy group, an isocyanate group, a carboxyl group, and a hydroxyl group), a polymerizable group (e.g., a vinyl group, an allyl group, and a (meth)acryloyl group) or others], a fluorine atom-containing photo-curable compound or resin which is curable by an actinic ray such as an ultra violet ray (for example, an ultra violet ray-curable compound such as a photo-curable fluorine-containing monomer or oligomer), and others.

The photo-curable compound may include, for example, a monomer, an oligomer (or a resin, in particular a low molecular weight resin). Examples of the monomer may include a fluorine atom-containing monomer corresponding to the monofunctional monomer and polyfunctional monomer exemplified in the paragraph of the anti-glare layer mentioned above [e.g., a monofunctional monomer such as a fluorine atom-containing (meth)acrylic monomer (such as a fluorinated alkyl ester of (meth)acrylic acid), or a vinyl-series monomer (such as a fluoroolefin); and a di(meth)acrylate of a fluorinated alkylene glycol such as 1-fluoro-1,2-di(meth)acryloyloxyethylene]. Moreover, a fluorine atom-containing oligomer or resin corresponding to the oligomer or resin exemplified in the paragraph of the anti-glare layer may be used as the oligomer or resin. These photo-curable compounds may be used alone or in combination.

The curable precursor for the fluorine-containing resin is, for example, available in the form of a liquid solution (coating liquid). For example, such a coating liquid may be available as “TT1006A” and “JN7215” manufactured by JSR Corporation, “DEFENSA TR-330” manufactured by Dainippon Ink and Chemicals, Inc., or others.

The thickness of the low-refraction-index layer may be, for example, about 0.05 to 2 μm, preferably about 0.07 to 1 μm, and more preferably about 0.08 to 0.3 μm.

The formation of the low-refraction-index layer on the anti-glare layer usually tends to decrease the haze to about 50 to 100% of that of anti-glare layer alone and to increase the transmitted image clarity to about 100 to 150% of that of the anti-glare layer alone. Therefore, when the low-reflection layer is formed, the haze and transmitted image clarity of the anti-glare layer alone may be adjusted to a slightly higher value and a slightly lower value than desired values, respectively, so as to adjust final haze and transmitted image clarity.

[Anti-Glare Film]

The anti-glare film of the present invention has a high transparency. The total light transmittance of the anti-glare film is, for example, about 80 to 100%, preferably about 85 to 100%, and particularly about 90 to 100%. Moreover, the anti-glare film of the present invention has a slight haze. For example, the haze of the anti-glare film is about 1 to 25%, preferably about 2 to 25%, and more preferably about 6 to 20%. The anti-glare film of the present invention has, particularly, as light internal haze. That is, the anti-glare layer having an uneven surface formed by phase separation contains no fine particle which leads to scattering in the interior of the layer, differently from an anti-glare layer obtained by a method which comprises dispersing a fine particle to form an uneven surface. Therefore, the haze in the interior of the layer (the internal haze leading to scattering in the interior of the layer) is low, for example, may be selected from the range of about 0 to 2% (e.g., about 0 to 1.5%) and is usually, about 0 to 1% (e.g., about 0.1 to 0.8% and preferably about 0.2 to 0.7%). Incidentally, the internal haze can be determined by coating the uneven surface of the anti-glare layer with a transparent resin layer or pasting a smooth transparent film on the uneven surface of the anti-glare layer joined by a transparent adhesive layer so as to planarize the uneven surface of the anti-glare layer, and measuring a haze of the planarized matter.

The total light transmittance and the haze can be measured using a NDH-5000W haze meter (manufactured by Nippon Denshoku Industries Co., Ltd.) in accordance with JIS (Japanese Industrial Standards) K7136.

When an image (transmitted image) clarity is measured by an image clarity measuring apparatus provided with an optical slit of 0.5 mm width, the anti-glare film of the present invention has a transmitted image clarity of about 25 to 75% and preferably about 28 to 73% (e.g., about 30 to 70%). The anti-glare film having a transmitted image clarity of about 35 to 75% (e.g., about 40 to 65%) can also be obtained. In such an anti-glare film, the outline (or contour) of a reflected image can be enough blurred. Therefore, a high anti-glareness can be obtained. When the anti-glare film has an excessively high transmitted image clarity, a strong ambient light penetrates to the anti-glare layer and is reflected from a mirror reflection layer in a display apparatus (for example, in the case of a liquid crystal cell, a glass surface of an upper electrode and a conductive surface of the upper electrode inside of the cell) without scattering, and the reflected light penetrates to the anti-glare layer with little scattering. Therefore, the anti-glare film having a high transmitted image clarity (for example, higher than 75%) cannot achieve reflection inhibition as desired. On the other hand, the anti-glare film having an excessively low transmitted image clarity can inhibit the reflection as mentioned above but deteriorates the image sharpness (or clearness). Incidentally, it is useful that the anti-glare film has a predetermined haze (particularly, the above-mentioned haze value) even when the transmitted image clarity is not larger than 75%. That is, the anti-glare film in which the haze (a measure of the degree of clouding) and the transmitted image clarity are within the above-mentioned ranges can effectively inhibit reflection of surrounding scenery.

The transmitted image clarity is a measure for quantifying defocusing or distortion of a light transmitted through a film. The transmitted image clarity is obtained by measuring a transmitted light from a film through a movable optical slit, and calculating amount of light in both a light part and a dark part of the optical slit. That is, in the case where a transmitted light is defocused by a film, the slit image formed on the optical slit becomes thicker, and as a result the amount of light in the transmitting part is not more than 100%. On the other hand, in the non-transmitting part, the amount of light is not less than 0% due to leakage of light. The value C of the transmitted image clarity is defined by the following formula according to the maximum value M of the transmitted light in the transparent part of the optical slit, and the minimum value m of the transmitted light in the opaque part thereof.

C(%)=[(M−m)/(M+m)]×100

That is, the closer the value C comes to 100%, the lower the image defocusing depending on the anti-glare film becomes. [reference; Suga and Mitamura, Tosou Gijutsu, July, 1985].

As an apparatus for measuring the transmitted image clarity, there may be used an image clarity measuring apparatus ICM-1T (manufactured by Suga Test Instruments Co., Ltd.). As the optical slit, there may be used an optical slit of 0.125 mm to 2 mm width.

Further, the anti-glare film of the present invention has, in the phase separation structure, an average distance between domains (two adjacent domains) substantially having regularity or periodicity. Therefore, the light being incident on the anti-glare film and transmitted through the anti-glare film shows maximum (local maximum) of the scattered light at a specific angle away from the rectilinear transmitted light by scattering (e.g. Bragg reflection) corresponding to the average distance between phases (or regularity of the uneven surface structure). That is, the anti-glare film of the present invention isotropically transmits and scatters or diffuses an incident light, while the scattered light (transmitted scattered-light) shows maximum value of the light intensity at a scattering angle which is shifted from the scattering center (for example, at about 0.1 to 10°, preferably about 0.2 to 5°, and particularly about 0.5 to 3°). Concerning an angle distribution profile of a scattered light intensity, the maximum value of the above-mentioned scattered light intensity may form peak-shapes separated from each other. Even when the angle distribution profile has a shoulder-shaped peak or a flat-shaped peak, it is regarded that the scattered light intensity has the maximum value.

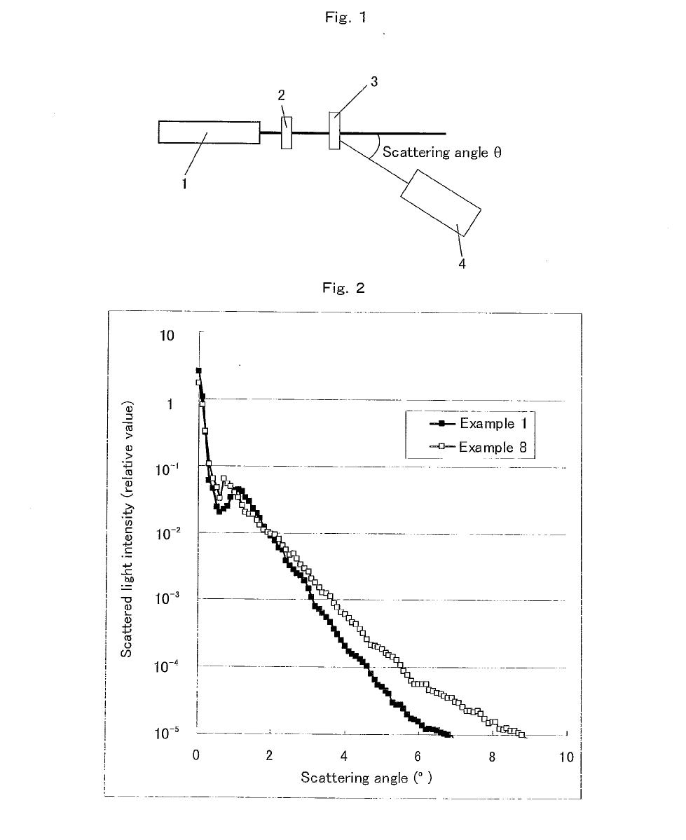

Incidentally, the angle distribution of the light transmitted through the anti-glare film can be measured by means of a measuring equipment comprising a laser beam source 1 such as He—Ne laser, and a beam receiver 4 set on a goniometer, as shown in FIG. 1. In the embodiment, the relationship between the scattered light intensity and the scattering angle θ is determined by irradiating a sample 3 with a laser beam from the laser beam source 1 through an ND filter 2, and detecting the scattered light from the sample by means of a detector (beam receiver) 4 which is capable of varying an angle at a scattering angle θ relative to a light path of the laser beam and comprises a photomultiplier. An automatic measuring equipment for laser beam scatteration (manufactured by NEOARK Corporation) is utilizable as such an equipment.

In the anti-glare film of the present invention the anti-glare layer adheres to the substrate film through the adhesive layer with a high adhesion strength. The adhesiveness can be evaluated as the following manner: (i) cutting a right-angle lattice pattern into the anti-glare layer with a cutter with 6 lines in each direction of the lattice pattern and the spacing of the lines in each direction of 2 mm (the number of 2-mm squares of the lattice: 25), (ii) bringing the anti-glare layer and an adhesive cellophane tape (manufactured by Nichiban Co., Ltd.) in tight contact with each other, (iii) pulling off the tape by hand quickly, and (iv) determining the adhesion of the cross-cut area based on the number of squares which were not detached (or peeled) from the substrate film. According to such a cross-cut test (cross-cut adhesion test), the anti-glare film has a residual ratio of the cross-cut area of not less than 90% (for example, about 90 to 100%, particularly about 96 to 100%).

The anti-glare layer in anti-glare film of the present invention has a high hardness and a damage prevention function. That is, the surface hardness (pencil hardness) of the anti-glare layer measured at a weight of 500 g in accordance with JIS K5400 is not lower than H (for example, about H to 3H).

According to the present invention, since the predetermined adhesive layer formed (or interposed) between the anti-glare layer and the substrate film comprising a cycloolefinic polymer allows a high adhesiveness of the anti-glare film to the substrate film, the range of choice of the component of the anti-glare layer can be broaden. Moreover, the anti-glare film can be adhered (or bonded) to the substrate film with a high adhesiveness while maintaining a high transparency, which is a characteristic of the cycloolefinic polymer. Further, since the cured anti-glare layer has a phase separation structure and an uneven surface structure, it is possible to achieve hardcoat property, antireflective property, and anti-glareness by the coated layer alone. Moreover, since the anti-glare film has an excellent anti-glareness, the anti-glare film prevents the reflection or dazzle of an ambient light and realizes display of an image in which a black color is clear or sharp (an image having a high light-room contrast) under an ambient light. Furthermore, the anti-glare film has a finely and regularly uneven surface structure without using an uneven surface structure formed by fine particles and has a high anti-glareness.

The anti-glare film of the present invention can prevent reflection of a surrounding scenery caused by surface reflection and improve anti-glareness, since the surface of the anti-glare layer has a plurality of finely uneven structures, corresponding to the phase separation structure. Moreover, the anti-glare layer has a high hardness and can serve as a hardcoat layer. In particular, the anti-glare layer of the anti-glare film according to the present invention has not only a high anti-glareness but also a high transmitted image clarity. Therefore, the anti-glare film of the present invention is useful for various applications which require anti-glareness and light-scattering property, for example, an optical member and an optical element (optical member) for a display apparatus (e.g., a liquid crystal display apparatus). Moreover, since the substrate film comprises a cycloolefinic polymer, the anti-glare film may be used as an optical member alone or used in combination with an optical element [for example, a variety of optical elements to be disposed in a light path, e.g., a polarizing plate, an optical retardation plate (or phase plate), and a light guide plate (or light guide)] to form an optical member. That is, the anti-glare film may be disposed or laminated on at least one light path surface of an optical element. For example, the anti-glare film may be laminated on at least one surface (a light path surface) of the optical element (such as a polarizing plate or an optical retardation plate) to form an optical member (a laminated optical member), or may be disposed or laminated on an output surface (or emerge surface) of the light guide plate.

The anti-glare film of the present invention comprises the anti-glare layer having an abrasion resistance imparted thereto, and the anti-glare film can also serve as a damage-preventing film (a protective film) for an outermost layer of an optical element or a display apparatus. A polarizing plate is practically disposed as an outermost layer in the liquid crystal display. The anti-glare film of the present invention is, therefore, suitably used for a laminate (optical member) in which the anti-glare film is used instead of at least one protective film between two protective films constituting a polarizing plate, that is, in which the anti-glare film is laminated on at least one surface of a polarizing plate. Such an optical member (particularly, a laminate of the polarizing plate and the anti-glare film) can effectively prevent reflection in a liquid crystal display apparatus, particularly, a large-screen liquid crystal display apparatus such as a high-definition or high-definitional liquid crystal display. Moreover, a laminate (optical member) which comprises an anti-glare film having an abrasion resistance imparted thereto is suitably used for a touch panel, which generates an input signal by touching a display screen image with a finger or a pen-type input device.

The anti-glare film of the present invention is preferably used for a television (TV) application, particularly, a television (TV) application for a contrastly projected image in which black color appears more sharply. Moreover, the anti-glare film can be used for a variety of display apparatuses or devices, for example, a liquid crystal display (LCD), a cathode ray tube display, an organic or inorganic EL display, a field emission display (FED), a surface-conduction electron-emitter display (SED), a rear projection television display, a plasma display (PDP), and a touch panel-equipped display device (a touch panel-equipped input device). Therefore, the present invention also includes a display apparatus provided with (or equipped with) the anti-glare film. The display apparatus comprises the anti-glare film or the optical member (particularly, a laminate of a polarizing plate and an anti-glare film) as an optical element. In particular, the anti-glare film can be preferably used for a liquid crystal display apparatus and others because the anti-glare film can inhibit reflection even in the case of being attached to a large-screen liquid crystal display apparatus such as a high-definition liquid crystal display and impart a high abrasion resistance to the optical element (e.g., a polarizing plate). Incidentally, the liquid crystal display apparatus may further comprise a prism sheet containing a prism unit having an approximately isosceles triangular cross-section.

Incidentally, the liquid crystal display apparatus may be a reflection-mode (or reflective) liquid crystal display apparatus using an ambient light (or outside light) for illuminating a display unit comprising a liquid crystal cell, or may be a transmission-mode (or transmissive) liquid crystal display apparatus comprising a backlight unit for illuminating a display unit. In the reflection-mode liquid crystal display apparatus, the display unit can be illuminated by taking in an incident light from the outside through the display unit, and reflecting the transmitted incident light by a reflective member. In the reflection-mode liquid crystal display apparatus, the anti-glare film or optical member (particularly a laminate of a polarizing plate and an anti-glare film) can be disposed in a light path in front of the reflective member. The anti-glare film or optical member can be disposed or laminated, for example, between the reflective member and the display unit, or in front of the display unit.

In the transmission-mode liquid crystal display apparatus, the backlight unit may comprise a light guide plate (e.g., a light guide plate having a wedge-shaped cross section) for allowing a light from a light source (e.g., a tubular light source such as a cold cathode tube, a point light source such as a light emitting diode) incident from one side of the light guide plate and for allowing the incident light to emit from the front output surface. When a plurality of light sources is disposed directly below a liquid crystal panel, the backlight unit may comprise a diffusing plate for obscuring the shape of the light sources. Moreover, if necessary, a prism sheet may be disposed in front of the light guide plate or diffusing plate. Incidentally, a reflective member for reflecting a light obtained from the light source to the output surface side is usually disposed on the reverse side of the light guide plate. In such a transmission-mode liquid crystal display apparatus, the anti-glare film or the optical member may usually be disposed or laminated in a light path in front of the light source. For example, the anti-glare film or optical member can be disposed or laminated between the light guide plate and the display unit, in front of the display unit, or others.

### EXAMPLES

The following examples are intended to describe this invention in further detail and should by no means be interpreted as defining the scope of the invention.

[Production of Cycloolefinic Polymer Film]

A cycloolefinic polymer (manufactured by Polyplastics Co., Ltd., trade name “TOPAS” grade 6013S-04) was melted in an extruder equipped with a T-die at a temperature of 270° C. and melt-extruded with the extruder on a chill roll at 100° C. at a drawing rate of 20 m/minute to give a film of 800 mm in width and 100 μm in thickness.

[Preparation of First Liquid Coating Composition and Formation of Adhesive Layer (Transparent Coating Layer)]

In 40.0 parts by weight of a mixed solvent containing methyl ethyl ketone (MEK) and 1-butanol in a ratio of MEK relative to 1-butanol of 8/2 (weight ratio) were dissolved 58.2 parts by weight of an acrylic ultra violet-curable monomer (or a mixture of acrylic ultra violet-curable monomers) as shown in the following Table 1. In the solution were dissolved 1.8 parts by weight of a cellulose acetate propionate (acetylation degree=2.5%, propionylation degree=46%, number average molecular weight in terms of polystyrene: 75000; manufactured by Eastman, Ltd., CAP-482-20) and 0.9 parts by weight of IRGACURE 184 and 0.9 parts by weight of IRGACURE 907 (each manufactured by Ciba Specialty Chemicals K.K.) as photoinitiators to prepare first liquid coating compositions 1 to 6.

Incidentally, the used acrylic ultra violet-curable monomers were dimethyloldicyclopentane diacrylate (manufactured by DAICEL-CYTEC Company, Ltd., IRR214K), pentaerythritol triacrylate (manufactured by DAICEL-CYTEC Company, Ltd., PETIA), dipentaerythritol hexaacrylate (manufactured by DAICEL-CYTEC Company, Ltd., DPHA), and trimethylolpropane triacrylate (manufactured by DAICEL-CYTEC Company, Ltd., TMPTA). The blending formulations of the prepared first liquid coating compositions 1 to 6 were shown in Table 1.

Each of the first liquid coating compositions 1 to 6 was applied on a surface of the cycloolefinic polymer film (1) with the use of a wire bar #28, and then the coated film was allowed to stand in an explosion-proof oven at 70° C. for 30 seconds for evaporation of the solvent. Thereafter, the coated film was passed through an ultra violet irradiation equipment (a high-pressure mercury lamp manufactured by Ushio Inc., dose of ultra violet ray; 800 mJ/cm²) for ultra violet curing treatment to form each of adhesive layers 1 to 6.

Table 1 shows the formulation of the first liquid coating compositions 1 to 6, the thickness of each adhesive layer, and the haze of each film.

TABLE 1

| | | | | | Film properties | |
|---|---|---|---|---|---|---|
| | Formulation of ultraviolet-curable | | | | Adhesive | |
| | monomer (weight ratio) | | | | layer | |
| | IRR214K | PETIA | DPHA | TMPTA | thickness | Haze |
| First liquid | 10 | 0 | 0 | 0 | 22 μm | 0.1% |
| coating | | | | | | |
| composition | | | | | | |
| 1 | | | | | | |
| First liquid | 7 | 3 | 0 | 0 | 22 μm | 0.1% |
| coating | | | | | | |
| composition | | | | | | |
| 2 | | | | | | |
| First liquid | 5 | 5 | 0 | 0 | 22 μm | 0.1% |
| coating | | | | | | |
| composition | | | | | | |
| 3 | | | | | | |
| First liquid | 5 | 0 | 5 | 0 | 22 μm | 0.1% |
| coating | | | | | | |
| composition | | | | | | |
| 4 | | | | | | |
| First liquid | 5 | 0 | 0 | 5 | 19 μm | 0.1% |
| coating | | | | | | |
| composition | | | | | | |
| 5 | | | | | | |
| First liquid | 7 | 0 | 0 | 3 | 21 μm | 0.1% |
| coating | | | | | | |
| composition | | | | | | |
| 6 | | | | | | |

[Preparation of Second Liquid Coating Composition (Coating Solution for Anti-Glare Layer)]

(Second Liquid Coating Composition A)

In a mixed solvent containing 39.1 parts by weight of methyl ethyl ketone (MEK), 11.2 parts by weight of 1-butanol, and 3.8 parts by weight of 1-methoxy-2-propanol (MMPG) were dissolved 28.3 parts by weight of dipentaerythritol hexaacrylate (manufactured by DAICEL-CYTEC Company, Ltd., DPHA) and 16.0 parts by weight of an acrylic resin having a polymerizable unsaturated group(s) at a side chain thereof [1-methoxy-2-propanol (MMPG) solution of a compound in which 3,4-epoxycyclohexenylmethyl acrylate is added to part of carboxyl groups of a (meth)acrylic acid-(meth)acrylate copolymer; manufactured by Daicel Chemical Industries, Ltd., ACAZ321M, solid content: 44% by weight], and 1.7 parts by weight of a cellulose acetate propionate (acetylation degree=2.5%, propionylation degree=46%, number average molecular weight in terms of polystyrene: 75,000; manufactured by Eastman, Ltd., CAP-482-20]. In the resulting solution, 0.5 parts by weight of IRGACURE 184 and 0.5 parts by weight of IRGACURE 907 (each manufactured by Ciba Specialty Chemicals K.K.) as photoinitiators and 0.2 parts by weight of a fluorine-containing polymerizable compound (manufactured by Omnova Solutions Inc.: Polyfox3320) as a stain-proofing agent were dissolved to prepare a second liquid coating solution A.

(Second Liquid Coating Composition B)

In a mixed solvent containing 35.1 parts by weight of methyl ethyl ketone (MEK) and 10.8 parts by weight of 1-butanol were dissolved 38.0 parts by weight of trimethylolpropane triacrylate (manufactured by DAICEL-CYTEC Company, Ltd., TMPTA), 14.6 parts by weight of an acrylic resin having a polymerizable unsaturated group(s) at a side chain thereof [1-methoxy-2-propanol (MMPG) solution of a compound in which 3,4-epoxycyclohexenylmethyl acrylate is added to part of carboxyl groups of a (meth)acrylic acid-(meth)acrylate copolymer; manufactured by Daicel Chemical Industries, Ltd., ACAZ321M, solid content: 44% by weight], and 1.6 parts by weight of a cellulose acetate propionate (acetylation degree=2.5%, propionylation degree=46%, number average molecular weight in terms of polystyrene: 75,000; manufactured by Eastman, Ltd., CAP-482-20). In the resulting solution, 0.5 parts by weight of IRGACURE 184 and 0.5 parts by weight of IRGACURE 907 (each manufactured by Ciba Specialty Chemicals K.K.) as photoinitiators and 0.1 parts by weight of the stain-proofing agent used in Example 1 were dissolved to prepare a second liquid coating solution B.

(Second Liquid Coating Composition C)

In a mixed solvent containing 52.0 parts by weight of methyl ethyl ketone (MEK) and 13.0 parts by weight of 1-methoxy-2-propanol (MMPG) were dissolved 30.1 parts by weight of trimethylolpropane triacrylate (manufactured by DAICEL-CYTEC Company, Ltd., TMPTA). To the solution were added 4.9 parts by weight of polystyrene beads having a mean particle size of 4 μm. In the resulting solution, 0.5 parts by weight of IRGACURE 184 and 0.5 parts by weight of IRGACURE 907 (each manufactured by Ciba Specialty Chemicals K.K.) as photoinitiators were dissolved to prepare a second liquid coating solution C.

### Example 1

The second liquid coating composition A was applied on a surface of the adhesive layer 1 with the use of a wire bar #24, and then the coated film was allowed to stand in an explosion-proof oven at 50° C. for 25 seconds for evaporation of the solvent. Thereafter, the coated film was passed through an ultra violet irradiation equipment (a high-pressure mercury lamp manufactured by Ushio Inc., dose of ultra violet ray; 800 mJ/cm²) for ultra violet curing treatment to form an anti-glare layer having a hardcoat property and an uneven surface structure. The total thickness of the coated layer (the total of the adhesive layer thickness and the anti-glare layer thickness) was 32 μm.

FIG. 2 represents the measurement results of a transmitted scattered-light intensity in the anti-glare film obtained in Example 1. In the figure, the results are plotted with scattering angle (θ in FIG. 1; that is, 0° means a transmitted straight light) as abscissa against scattered light intensity as ordinate (there is no unit because a relative intensity is measured). As apparent from this figure, the maximum value of the peak of the scattered light intensity is observed at a scattering angle of around 1.1°.

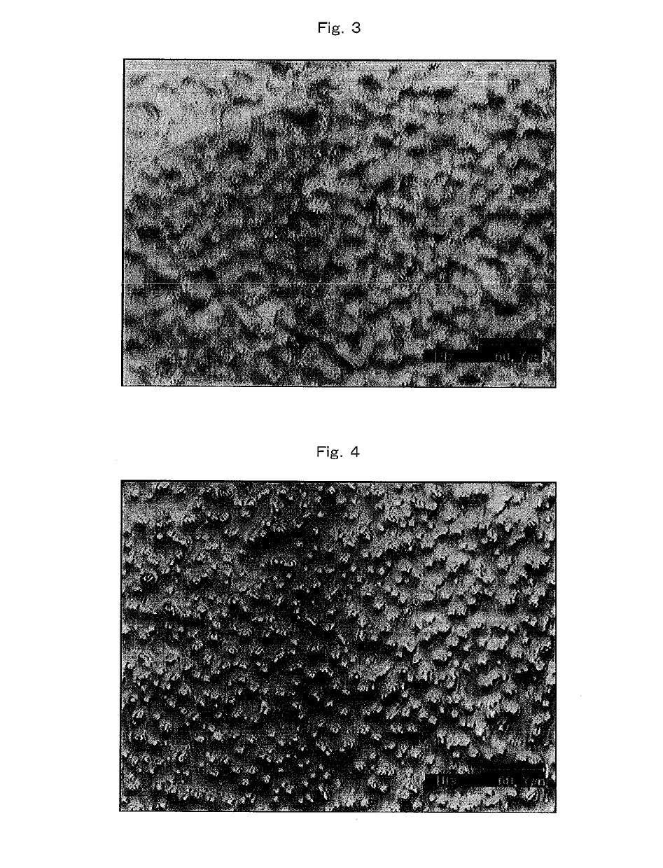

FIG. 3 represents the observation results of the surface of the anti-glare film obtained in Example 1 by a laser microscope. Protruded regions are formed as islands independent from each other or islands partly linked by linkage, and these islands are uniformly and impartially dispersed in the visual field. The average cycle of the uneven structure probably corresponds to the maximum of the scattered light in FIG. 2.

### Example 2

The second liquid coating composition A was applied on a surface of the adhesive layer 2 with the use of a wire bar #24, and then the coated film was allowed to stand in an explosion-proof oven at 50° C. for 25 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 34 μm.

### Example 3

The second liquid coating composition A was applied on a surface of the adhesive layer 3 with the use of a wire bar #24, and then the coated film was allowed to stand in an explosion-proof oven at 50° C. for 25 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 33 μm.

### Example 4

The second liquid coating composition A was applied on a surface of the adhesive layer 4 with the use of a wire bar #24, and then the coated film was allowed to stand in an explosion-proof oven at 50° C. for 25 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 34 μm.

### Example 5

The second liquid coating composition A was applied on a surface of the adhesive layer 5 with the use of a wire bar #24, and then the coated film was allowed to stand in an explosion-proof oven at 50° C. for 25 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 33 μm.

### Example 6

The second liquid coating composition A was applied on a surface of the adhesive layer 6 with the use of a wire bar #24, and then the coated film was allowed to stand in an explosion-proof oven at 50° C. for 25 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 33 μm.

### Example 7

The second liquid coating composition B was applied on a surface of the adhesive layer 5 with the use of a wire bar #28, and then the coated film was allowed to stand in an explosion-proof oven at 70° C. for 20 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 36 μm.

### Example 8

The second liquid coating composition B was applied on a surface of the adhesive layer 6 with the use of a wire bar #30, and then the coated film was allowed to stand in an explosion-proof oven at 70° C. for 20 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 38 μm.

FIG. 2 represents the measurement results of a transmitted scattered-light in the anti-glare film obtained in Example 8. As apparent from this figure, the maximum value of the peak of the scattered light is observed at a scattering angle of around 0.7°.

FIG. 4 represents the observation results of the surface of the anti-glare film by a laser microscope. Protruded regions are formed as islands independent from each other, and these islands are uniformly and impartially dispersed in the visual field. The average cycle of the uneven structure probably corresponds to the maximum of the scattered light in FIG. 2.

### Comparative Example 1

The second liquid coating composition A was applied on a surface of the cycloolefinic polymer film (1) with the use of a wire bar #22, and then the coated film was allowed to stand in an explosion-proof oven at 50° C. for 25 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 12 μm.

### Comparative Example 2

The second liquid coating composition C was applied on a surface of the adhesive layer 2 with the use of a wire bar #22, and then the coated film was allowed to stand in an explosion-proof oven at 70° C. for 20 seconds for evaporation of the solvent. Then, in the same manner as in Example 1, the coated film was subjected to the ultra violet curing treatment, and an anti-glare layer having a hardcoat property and an uneven surface structure was obtained. The total thickness of the coated layer (the total of the adhesive layer thickness and the anti-glare layer thickness) was 31 μm.

For each of anti-glare films obtained in Examples 1 to 8 and Comparative Examples 1 and 2, the total light transmittance, the haze, the internal haze, the transmitted image clarity, the peak angle showing the maximum of transmitted scattered-light intensity, the coated layer adhesiveness, and the pencil hardness were measured as follows. Further, each anti-glare film was mounted on a liquid crystal display apparatus, and the anti-glareness and others were evaluated.

[Measurements of Haze and Total Light Transmittance]

The haze and the total light transmittance were measured with a haze meter manufactured by Nippon Denshoku Industries Co., Ltd. (the trade name “NDH-5000W”). The anti-glare film alone was disposed so as to face the anti-glare layer of the film toward a beam receiver, and the total haze was measured.

A cycloolefinic polymer film (1) used as a substrate film was pasted on the anti-glare layer of the anti-glare film with a transparent pressure sensitive double-faced adhesive (thickness: about 25 μm) to give a film having no uneven surface, and the internal haze of the resulting film was measured.

[Measurement of Transmitted Image Clarity]

The transmitted image clarity of the anti-glare film was measured in accordance with JIS K7105 with an image clarity measuring apparatus (manufactured by Suga Test Instruments Co., Ltd., the trade name “ICM-1T”) provided with an optical slit (the slit width=0.5 mm).

[Measurement of Transmitted Scattered-Light Intensity]

The angle distribution of the light transmitted through the anti-glare film was measured using a He—Ne laser as a light source and a measuring equipment provided with a beam receiver set on a goniometer (a laser light scattering automatic measuring equipment: manufactured by NEOARK Corporation) as represented by FIG. 1. The peak of the transmitted scattered light intensity was determined as follows: in the angle distribution profile of the scattered light intensity, even when the angle distribution profile has a separated peak, a shoulder-shaped peak or a flat-shaped peak, it was regarded that the scattered light intensity had a maximum value, and the angle was given as a peak angle.

[Method for Evaluating Adhesiveness of Coated Layer]

The adhesiveness of the coated layer was evaluated as the following manner: (i) cutting a right-angle lattice pattern into the anti-glare layer with a cutter with 6 lines in each direction of the lattice pattern and the spacing of the lines in each direction of 2 mm (the number of 2-mm squares of the lattice: 25), (ii) bringing the anti-glare layer and an adhesive cellophane tape (manufactured by Nichiban Co., Ltd.) in tight contact with each other, (iii) pulling off the tape by hand quickly, and (iv) determining the adhesion of the cross-cut area based on the number of squares which were not detached (or peeled) from the substrate film.

[Measurement of Pencil Hardness]

The hardness was measured and evaluated in accordance with JIS K5400. The weight was 500 g.

[Mounting Evaluation]

The mounting evaluation was carried out using a liquid crystal display apparatus (manufactured by Sharp Corporation, “AQUOS LC20AX5”). Incidentally, a front polarizing plate was replaced with a clear polarizing plate, and each of anti-glare films obtained in Examples 1 to 8 and Comparative Examples 1 and 2 was pasted on the clear polarizing plate through a transparent pressure sensitive double-faced adhesive. The mounting was visually evaluated on the basis of the following criteria.

(Anti-Glareness)

A fluorescent lamp having an exposed (uncovered) fluorescent tube was used. The reflected light of the lamp on the panel surface was visually observed, and the blurring of the reflected outline of the fluorescent tube was evaluated on the basis of the following criteria.

“A”: No reflected outline of the fluorescent lamp is observed.

“B”: The reflected outline of the fluorescent lamp is slightly observed, but it is negligible.

“C”: The reflected outline of the fluorescent lamp is observed, and it is slightly considerable.

“D”: The strongly reflected outline of the fluorescent lamp is observed, and it is very considerable.

(Blackness)

In a light-room environment, a black color image was displayed, and the surface of the display panel was visually observed whether the surface appeared black, and evaluated on the basis of the following criteria.

“A”: The surface sufficiently appears black.

“B”: The surface appears black.

“C”: The surface does not appear very black.

“D”: The surface hardly appears black.

(Dazzle)

In an environment that no ambient light was reflected, green color image was displayed on the liquid crystal panel. The green color image was observed at a distance of about 50 cm from the liquid crystal panel. The visual evaluation on dazzle was conducted on the basis of the following criteria.

“A”: No dazzle is recognized at all.

“B”: Dazzle is hardly recognized.

“C”: Dazzle is slightly recognized.

“D”: Dazzle is recognized.

The results are shown in Table 2.

TABLE 2

| | Examples | | | | |
|---|---|---|---|---|---|
| | 1 | 2 | 3 | 4 | 5 |
| First liquid coating | 1 | 2 | 3 | 4 | 5 |
| composition (No.) | | | | | |
| Second liquid coating | A | A | A | A | A |
| composition (No.) | | | | | |
| Mechanism of uneven | phase | phase | phase | phase | phase |
| surface formation | separation | separation | separation | separation | separation |
| Optical properties | | | | | |
| Total light transmittance (%) | 90.5 | 90.6 | 90.4 | 90.5 | 90.4 |
| Haze (%) | 6.9 | 6.3 | 7.0 | 7.2 | 7.5 |
| Internal haze (%) | 0.3 | 0.3 | 0.3 | 0.3 | 0.3 |
| Transmitted image clarity (%) | 60 | 66 | 60 | 62 | 54 |
| Peak position of scattered | 1.1° | 1.1° | 1.0° | 1.4° | 1.2° |
| light intensity | | | | | |
| Physical properties | | | | | |
| Thickness (μm) | 32 | 34 | 33 | 34 | 33 |
| Adhesiveness of coated layer | 25/25 | 25/25 | 25/25 | 25/25 | 25/25 |
| Pencil hardness | 2H | 2H | 2H | 2H | 2H |
| Mounting evaluation | | | | | |
| Anti-glareness | B | B | B | B | A |
| Blackness | A | A | A | A | A |
| Dazzle | A | A | A | A | A |
| | | | | Comparative | |
| | Examples | | | Examples | |
| | 6 | 7 | 8 | 1 | 2 |
| First liquid coating | 6 | 5 | 6 | none | 2 |
| composition (No.) | | | | | |
| Second liquid coating | A | B | B | A | C |
| composition (No.) | | | | | |
| Mechanism of uneven | phase | phase | phase | phase | fine |
| Surface formation | separation | separation | separation | separation | particle |
| Optical properties | | | | | |
| Total light transmittance (%) | 90.6 | 90.5 | 90.2 | 90.5 | 90.3 |
| Haze (%) | 6.0 | 3.8 | 6.0 | 7.8 | 25.0 |
| Internal haze (%) | 0.3 | 0.3 | 0.3 | 0.3 | 18.0 |
| Transmitted image clarity (%) | 57 | 52 | 44 | 52 | 25 |
| Peak position of scattered | 0.8° | 0.8° | 0.7° | 1.2° | none |
| light intensity | | | | | |
| Physical properties | | | | | |
| Thickness (μm) | 33 | 36 | 38 | 12 | 31 |
| Adhesiveness of coated layer | 25/25 | 25/25 | 25/25 | 0/25 | 25/25 |
| Pencil hardness | 2H | 2H | 3H | H | H |
| Mounting evaluation | | | | | |
| Anti-glareness | B | B | B | B | B |
| Blackness | A | A | A | A | D |
| Dazzle | A | A | A | A | C |

As apparent from Table 2, the anti-glare films of Examples 1 to 8 have not only an excellent adhesiveness of coated layer and a high pencil hardness but also reflected light properties effective in anti-glareness due to the uniform uneven structure generated by phase separation and excellent properties in the mounting evaluation. On the other hand, the anti-glare film of Comparative Example 1 has excellent optical properties due to the anti-glare layer having a phase separation structure while the anti-glare film has extremely insufficient adhesiveness of coated layer. Moreover, the anti-glare film of Comparative Example 2 has an uneven surface formed by fine particles. Therefore, the anti-glare film has insufficient results in the item “Blackness” due to the internal haze in the mounting evaluation, and dazzle due to ununiformly uneven surface is slightly recognized.

What is claimed is:

1. An anti-glare film comprising
a substrate film comprising a cycloolefinic polymer,
an anti-glare layer, and
an adhesive layer formed between the substrate film and the anti-glare layer,
wherein the adhesive layer is (A-1) a cured layer of (A-2) a curable composition containing at least one of a curable component, the curable component comprises at least (A-3) a ring-containing curable component selected from the group consisting of a mono- or di(meth)acrylate having an alicyclic hydrocarbon ring and a mono- or di(meth)acrylate having a crosslinked cyclic hydrocarbon ring,
the anti-glare layer is (B-1) a cured layer of (B-2) a curable resin composition and has a phase separation structure and an uneven surface structure, and the curable resin composition (B-2) comprises a plurality of components being capable of phase separation and containing at least (B-3) a curable component.

2. An anti-glare film according to claim 1, wherein the proportion of the ring-containing curable component (A-3) in the total curable component of the curable composition (A-2) is not less than 30% by weight.

3. An anti-glare film according to claim 1, wherein the curable composition (A-2) further contains a cellulose derivative.

4. An anti-glare film according to claim 1, wherein the anti-glare layer comprises
an active energy ray-curable resin precursor having a plurality of photopolymerizable groups and
at least one polymer component;
wherein at least two components of the curable resin precursor and the polymer component form a phase separation structure due to phase separation from a liquid phase; and
the curable resin precursor has been cured.

5. An anti-glare film according to claim 1, wherein the curable resin composition (B-2) contains a polyfunctional (meth)acrylate having a plurality of (meth)acryloyl groups, a cellulose derivative, and a polymer component having a (meth)acryloyl group.

6. An anti-glare film according to claim 1, wherein the adhesive layer is formed with tricyclodecanedimethaol di(meth)acrylate and a cellulose ester, and the anti-glare layer is formed with a polyfunctional (meth)acrylate, a cellulose ester, a polymer component having a (meth)acryloyl group at a side chain thereof.

7. An anti-glare film according to claim 1, which isotropically transmits and scatters an incident light to show a maximum value of a scattered light intensity at a scattering angle of 0.1 to 10° and has a total light transmittance of 80 to 100%.

8. An anti-glare film according to claim 1, which has a total haze of 1 to 25%, an internal haze of 0 to 1%, and a transmitted image clarity of 25 to 75% measured with an image clarity measuring apparatus provided with an optical slit of 0.5 mm width.

9. An anti-glare film according to claim 1, wherein the anti-glare layer has
a residual ratio of a cross-cut area of not less than 90% in accordance with a cross-cut test and
a pencil hardness of not lower than H.

10. A process for producing an anti-glare film, which comprises
an applying step for applying a first liquid coating composition on a surface of a substrate film comprising a cycloolefinic polymer,
the first liquid coating composition comprising a curable composition containing at least one curable component selected from the group consisting of a mono- or di(meth)acrylate having an alicyclic hydrocarbon ring and a mono- or di(meth)acrylate having a crosslinked cyclic hydrocarbon ring,
an applying step for applying a second liquid coating composition on the coated surface,
the second liquid coating composition comprising a curable resin composition containing a plurality of components and a solvent, and the plurality of components being capable of phase separation and containing at least one curable component,
a phase-separation step for forming a phase separation structure by phase separation with evaporating the solvent, and
a step for curing the curable components of each of the first and second compositions.

11. A process according to claim 10, wherein
the first liquid coating composition for an adhesive layer contains a tricyclodecanedimethaol di(meth)acrylate, a cellulose derivative, a photopolymerization initiator, and a first solvent dissolving these components,
the second liquid coating composition for an anti-glare layer contains a polyfunctional (meth)acrylate having a plurality of (meth)acryloyl groups, a cellulose derivative, a polymer component having a (meth)acryloyl group, a photopolymerization initiator, and a second solvent dissolving these components,
the curing is carried out with light irradiation, and
the curing step is carried out at least after the phase-separation step.

12. A process according to claim 11, which further comprises a drying step for drying a coated layer of the first liquid coating composition for forming a first layer, and an evaporating step for evaporating the second solvent from a coated layer of the second liquid coating composition for forming a second layer having the phase separation structure, wherein the curing step comprises the following (1) or (2):
(1) a first step for curing the first layer and a second step for curing the second layer, or
(2) a step for curing the first layer and the second layer.

13. A process according to claim 10, wherein the substrate film is used without any surface treatment.

14. A display apparatus provided with an anti-glare film recited in claim 1.

15. A display apparatus according to claim 14, which is selected from the group consisting of a liquid crystal display, a cathode ray tube display, a plasma display, and a touch panel-equipped input device.
